(19) United States
(12) Patent Application Publication
(10) Pub. No.: US 2019/0086903 A1
(43) Pub. Date: Mar. 21, 2019

(54) PLANT MANAGEMENT SYSTEM, PLANT MANAGEMENT METHOD, PLANT MANAGEMENT APPARATUS, AND PLANT MANAGEMENT PROGRAM

(71) Applicant: NEC CORPORATION, Tokyo (JP)

(72) Inventor: Katsuhiro OCHIAI, Tokyo (JP)

(73) Assignee: NEC CORPORATION, Tokyo (JP)

(21) Appl. No.: 16/089,893

(22) PCT Filed: Feb. 20, 2017
(86) PCT No.: PCT/JP2017/006174

§ 371 Date: Sep. 28, 2018

(30) Foreign Application Priority Data
Mar. 30, 2016 (JP) 2016-068251

(51) Int. Cl. G05B 19/418

(52) U.S. Cl. CPC G05B 19/41865; G05B 2219/31449

(57) ABSTRACT

The present invention is directed to a plant management system that actively incorporates the sense or experience of an operator who observes or inspects a plant on work site in plant management processing. The plant management system includes an acquirer that acquires at least a position in which an abnormality suspicious event suspected to be abnormal by an operator on work site has occurred, a sensor specifier that specifies a sensor associated with the abnormality suspicious event based on the at least a position in which the abnormality suspicious event has occurred, and a setter that sets an information collection method in accordance with the specified sensor. In addition, at least one of a type of the abnormality suspicious event and an occurrence time of the abnormality suspicious event may be taken into consideration to specify the sensor.

### CROSS REFERENCE TO RELATED APPLICATIONS

This application is based upon and claims the benefit of priority from Japanese patent application No. 2016-068251, filed on Mar. 30, 2016, the disclosure of which is incorporated herein in its entirety by reference.

### TECHNICAL FIELD

The present invention relates to a plant management system, a plant management method, a plant management apparatus, and a plant management program.

### BACKGROUND ART

In the technical field, patent literature 1 discloses a technique of causing a patrol apparatus to make a patrol in cooperation with the operation schedule of a plant, collect device operation information representing an atmospheric operation state such as the temperature, abnormal noise, or vibration of a plant device, and display the information to a plant monitoring apparatus for performing central monitoring together with monitoring information of the plant device obtained by various kinds of sensors installed in advance at the measurement points of the plant device. In addition, cited literature 2 discloses a technique of, in a case in which an abnormality sign is diagnosed for a measurement signal from a detector of the plant, obtaining a pipe or a device located on the upstream side of a pipe or a device to which the detector that has diagnosed the abnormality sign is attached and a measurement signal at that position in association with each other and displaying them on a monitor.

### CITATION LIST

### Patent Literature

Patent literature 1: Japanese Patent Laid-Open No. 2012-133509

Patent literature 2: WO 2011/061793

### SUMMARY OF THE INVENTION

### Technical Problem

In the techniques described in the above literatures, however, it is impossible to actively incorporate the sense or experience of an operator who observes or inspects a plant on work site in plant management processing.

The present invention enables to provide a technique of solving the above-described problem.

### Solution to Problem

One example aspect of the present invention provides a plant management system comprising:

an acquirer that acquires at least a position in which an abnormality suspicious event suspected to be abnormal by an operator on a work site has occurred;

a sensor specifier that specifies a sensor associated with the abnormality suspicious event based on the at least a position in which the abnormality suspicious event has occurred; and

a setter that sets an information collection method in accordance with the specified sensor.

Another example aspect of the present invention provides a plant management method comprising:

acquiring at least a position in which an abnormality suspicious event suspected to be abnormal by an operator on work site has occurred;

specifying a sensor associated with the abnormality suspicious event based on the at least a position in which the abnormality suspicious event has occurred; and

setting an information collection method in accordance with the specified sensor.

Still other example aspect of the present invention provides a plant management apparatus comprising:

an acquirer that acquires at least a position in which an abnormality suspicious event suspected to be abnormal has occurred from a terminal carried by an operator on work site;

a sensor specifier that specifies a sensor associated with the abnormality suspicious event based on the at least a position in which the abnormality suspicious event has occurred; and

an instructor that instructs to set an information collection method in accordance with the specified sensor.

Yet other example aspect of the present invention provides a plant management program for causing a computer to execute a method, comprising:

displaying, on a terminal carried by an operator on work site, a list of tasks to be performed by the operator;

acquiring, from the terminal, at least a position in which an abnormality suspicious event suspected to be abnormal has occurred; and

presenting information of a sensor associated with the abnormality suspicious event, the sensor being specified based on the at least a position in which the abnormality suspicious event has occurred.

Still other example aspect of the present invention provides a plant management program for causing a computer to execute a method, comprising:

acquiring at least a position in which an abnormality suspicious event suspected to be abnormal has occurred from a terminal carried by an operator on work site;

specifying a sensor associated with the abnormality suspicious event based on the at least a position in which the abnormality suspicious event has occurred; and

instructing to set an information collection method in accordance with the specified sensor.

Yet other example aspect of the present invention provides a plant management program for causing a computer to execute a method, comprising:

accumulating, in an accumulator, a position in which an abnormality suspicious event suspected to be abnormal has occurred and which is acquired from a terminal carried by an operator on work site;

determining an abnormality suspicious sensor associated with the abnormality suspicious event by referring to the accumulator; and

instructing to set an information collection method of a sensor specified based on the position in which the abnormality suspicious event has occurred, with reflecting occurrence of the abnormality suspicious event on ranking display of the abnormality suspicious sensor.

### Advantageous Effects of Invention

According to the present invention, it is possible to actively incorporate the sense or experience of an operator who observes or inspects a plant on work site in plant management processing.

### BRIEF DESCRIPTION OF DRAWINGS

FIG. 1 is a block diagram showing the arrangement of a plant management system according to the first example embodiment of the present invention;

FIG. 2 is a view showing the operation outline of a plant management system according to the second example embodiment of the present invention;

FIG. 3 is a view showing the operation outline of a plant management system according to an existing technique;

FIG. 4 is a block diagram showing the functional arrangement of the plant management system according to the second example embodiment of the present invention;

FIG. 5A is a block diagram showing the hardware arrangement of the plant management system according to the second example embodiment of the present invention;

FIG. 5B is a block diagram showing the software configuration of the plant management system according to the second example embodiment of the present invention;

FIG. 5C is a view showing the workflow of the plant management system according to the second example embodiment of the present invention;

FIG. 6A is a sequence chart showing an operation procedure of the plant management system according to the second example embodiment of the present invention;

FIG. 6B is a sequence chart showing another operation procedure of the plant management system according to the second example embodiment of the present invention;

FIG. 7A is a block diagram showing the functional arrangement of a data accumulator according to the second example embodiment of the present invention;

FIG. 7B is a view showing the arrangement of an abnormality suspicious information database according to the second example embodiment of the present invention;

FIG. 7C is a view showing the arrangement of a sensor position database according to the second example embodiment of the present invention;

FIG. 7D is a flowchart showing the operation procedure of the data accumulator according to the second example embodiment of the present invention;

FIG. 8A is a block diagram showing the functional arrangement of a workflow controller according to the second example embodiment of the present invention;

FIG. 8B is a view showing the arrangement of a sensor specifying table according to the second example embodiment of the present invention;

FIG. 8C is a view showing the arrangement of an information collection method setting table according to the second example embodiment of the present invention;

FIG. 8D is a flowchart showing the operation procedure of the workflow controller according to the second example embodiment of the present invention;

FIG. 9 is a view showing the workflow of a work in the plant management system according to the second example embodiment of the present invention;

FIG. 10A is a view showing an arrangement for implementing the first information collection method in the plant management system according to the second example embodiment of the present invention;

FIG. 10B is a view showing a workflow for implementing the first information collection method according to the second example embodiment of the present invention;

FIG. 11A is a view showing an arrangement for implementing the second information collection method in the plant management system according to the second example embodiment of the present invention;

FIG. 11B is a view showing a workflow for implementing the second information collection method according to the second example embodiment of the present invention;

FIG. 12A is a view showing an arrangement for implementing the third information collection method in the plant management system according to the second example embodiment of the present invention;

FIG. 12B is a view showing a workflow for implementing the third information collection method according to the second example embodiment of the present invention;

FIG. 13A is a view showing an arrangement for implementing the fourth information collection method in the plant management system according to the second example embodiment of the present invention;

FIG. 13B is a view showing a workflow for implementing the fourth information collection method according to the second example embodiment of the present invention;

FIG. 14A is a view showing an arrangement for implementing the fifth information collection method in the plant management system according to the second example embodiment of the present invention;

FIG. 14B is a view showing a workflow for implementing the fifth information collection method according to the second example embodiment of the present invention;

FIG. 15A is a view showing an arrangement for implementing the sixth information collection method in the plant management system according to the second example embodiment of the present invention;

FIG. 15B is a view showing a workflow for implementing the sixth information collection method according to the second example embodiment of the present invention;

FIG. 16A is a view showing an arrangement for implementing the seventh information collection method in the plant management system according to the second example embodiment of the present invention;

FIG. 16B is a view showing a workflow for implementing the seventh information collection method according to the second example embodiment of the present invention;

FIG. 17A is a view showing an arrangement for implementing the eighth information collection method in the plant management system according to the second example embodiment of the present invention;

FIG. 17B is a view showing a workflow for implementing the eighth information collection method according to the second example embodiment of the present invention; and

FIG. 18 is a view showing a workflow for controlling setting/end of the information collection method according to the second example embodiment of the present invention.

### DESCRIPTION OF EXAMPLE EMBODIMENTS

Example embodiments of the present invention will now be described in detail with reference to the drawings. It should be noted that the relative arrangement of the components, the numerical expressions and numerical values set forth in these example embodiments do not limit the scope of the present invention unless it is specifically stated otherwise.

Note that a term “abnormality suspicious event” used in this specification means occurrence of a phenomenon that occurs in association with, for example, a structure such as a plant and is suspected to be abnormal, and indicates all phenomena such as a smell, abnormal noise, vibration, a screw dropped on the floor, flashing, a liquid on the floor, and a smoke and steam, which are not observed under a normal operation environment. In addition, a term “abnormality suspicious information” includes the information of an abnormality suspicious event that has occurred, the occurrence position of an associated abnormality suspicious event, the occurrence time of the abnormality suspicious event, and the like. Furthermore, a term “sensor information” indicates measurement information detected by a sensor shown on a drawing and time-series data thereof unless it is specifically stated otherwise.

### First Example Embodiment

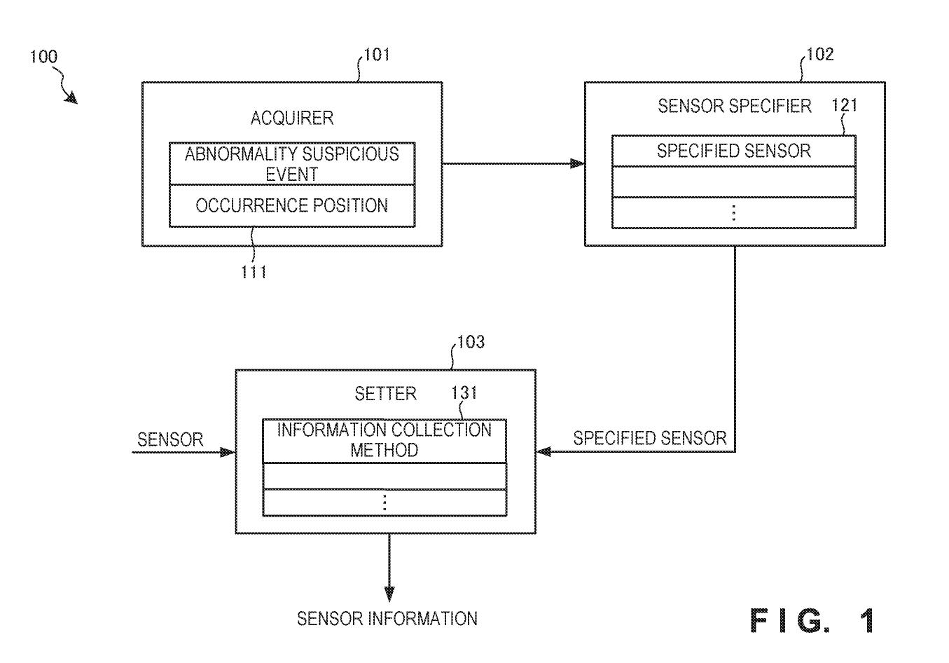

A plant management system 100 according to the first example embodiment of the present invention will be described with reference to FIG. 1. The plant management system 100 is a system configured to check or maintain a plant or the like.

As shown in FIG. 1, the plant management system 100 includes an acquirer 101, a sensor specifier 102, and a setter 103. The acquirer 101 acquires at least a position 111 where an abnormality suspicious event suspected to be abnormal by an operator on work site has occurred. The sensor specifier 102 specifies at least a sensor 121 associated with the abnormality suspicious event based on the position where the abnormality suspicious event has occurred. The setter 103 sets an information collection method 131 concerning the specified sensor.

According to this example embodiment, the information collection method concerning the sensor is set using the information of the abnormality suspicious event suspected to be abnormal by the operator on work site. It is therefore possible to actively incorporate the sense or experience of the operator who observes or inspects the plant on work site in plant management processing.

### Second Example Embodiment

A plant management system according to the second example embodiment of the present invention will be described next. The plant management system according to this example embodiment accumulates the information of an abnormality suspicious event suspected to be abnormal by an operator on work site, specifies a sensor based on the occurrence position of the abnormality suspicious event, and sets an information collection method for the sensor. For example, the sensor to be used is discriminated, involvement of sensor information in analysis by an analysis engine is changed, or observation information on work site is acquired based on the analysis result of the analysis engine.

The position where the abnormality suspicious event has occurred is acquired based on the position of a terminal carried by the operator. In addition, a sensor located within a predetermined distance corresponding to the type of the abnormality suspicious event from the position where the abnormality suspicious event has occurred or a sensor located at a position associated with the position where the abnormality suspicious event has occurred in correspondence with the type of the abnormality suspicious event is specified. For example, a sensor located near the place where the abnormality suspicious event has occurred or at a logically associated position or sensor located on a nearby upstream side of an abnormality-registered place is included. Furthermore, the sensor is specified in consideration of the occurrence time of the abnormality suspicious event as well. In addition, information representing disappearance of the abnormality suspicious event from the operator on work site is acquired, and the information representing disappearance of the abnormality suspicious event is also accumulated.

Note that as the terminal in this example embodiment, for example, an HMD (Head Mounted Display), a portable telephone, a smartphone, a tablet, or the like is used. The terminal may be an autonomous movable robot or drone capable of acquiring the information of the site. In this case, a designated point or direction is indicated to the robot or drone, and sound recording or video capturing is instructed, thereby detecting occurrence of an abnormality suspicious event. Detection by the robot or drone and a notification to the management center serve as the report of occurrence of the abnormality suspicious event by observation of the operator.

<<Existing Plant Management System>>

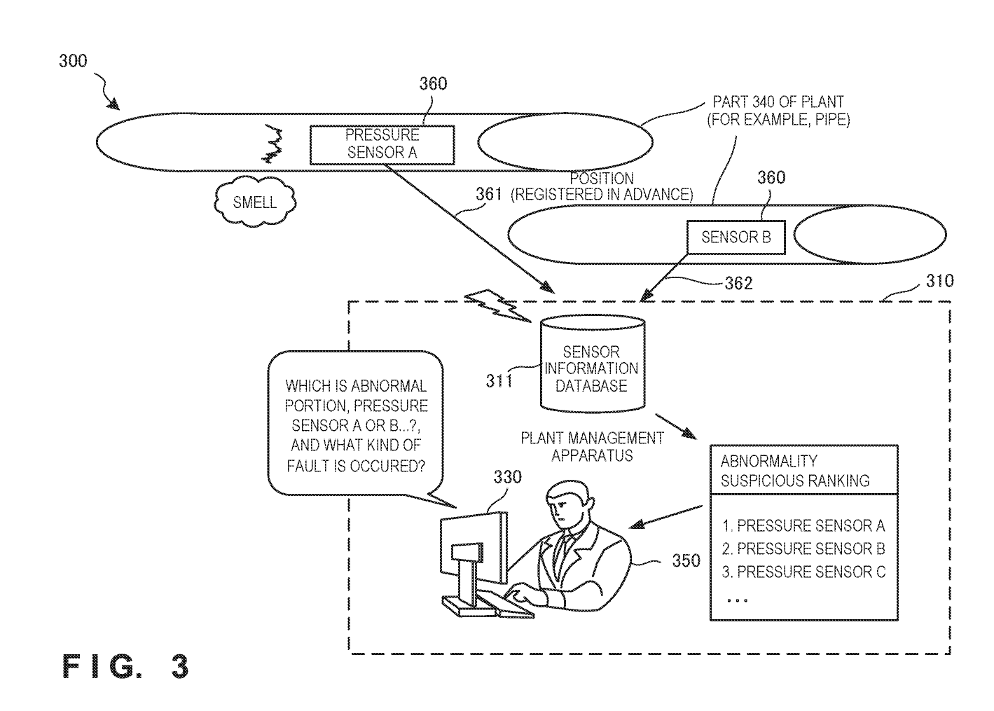

First, to explicitly show the features of this example embodiment, the operation outline of a plant management system 300 according to an existing technique will be described with reference to FIG. 3.

The plant management system 300 is a system configured to monitor or maintain a structure such as a plant. For example, in the management center of the plant management system 300, various kinds of sensors 360 are arranged to collect pieces of sensor information 361 and 362. The pieces of sensor information are accumulated in a database 311, and it is monitored whether an abnormality or fault exists or not. Note that if an abnormality is recognized, a manager 350 instructs from a management center terminal 330 to analyze the sensor information accumulated in the database 311. For example, a ranking of suspicious sensors as the cause of the abnormality may be generated, and an operator on the corresponding site may be instructed to do observation. If an abnormality or fault is found, or if an abnormality or fault is predicted by analysis of the sensor information, the manager 350 instructs the site to perform a maintenance operation from the management center terminal 330.

However, since the abnormal portion, the abnormality type, and the cause are narrowed down only from collected data, a phenomenon that does not appear in data cannot be taken into consideration for analysis.

<<Plant Management System of This Example Embodiment>>

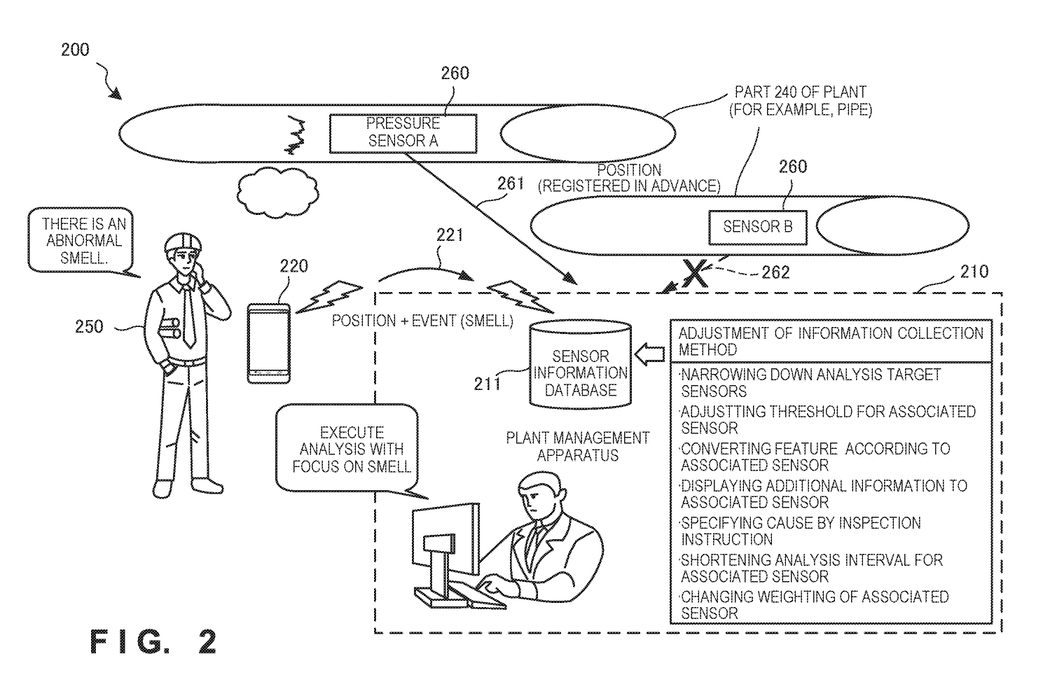

The arrangement and operation of a plant management system 200 according to this example embodiment will be described with reference to FIGS. 2 and 4 to 6.

(Operation Outline)

FIG. 2 is a view showing the operation outline of the plant management system 200 according to this example embodiment.

The plant management system 200 is a system configured to monitor or maintain a structure such as a plant. For example, the management center of the plant management system 200 includes a plant management apparatus 210 including a sensor information database 211. Sensor information collected from a sensor 260 installed in a part 240 (to be also referred to as a measurement target hereinafter) of the plant in FIG. 2 is accumulated in the sensor information database 211. The sensor information is analyzed by an analysis engine (not shown), and plant management, for example, monitoring or maintenance is performed.

Assume here that the plant management apparatus 210 receives abnormality suspicious information 221 sent from a terminal 220 carried by an operator 250 on work site. This is information representing that, for example, there is an abnormal smell. The plant management apparatus 210 that has received the abnormality suspicious information 221 specifies a sensor associated with the abnormality suspicious information by defining position information acquired by the terminal 220 that is the transmission source of the abnormality suspicious information 221 as the occurrence position of the abnormality suspicious information, and adjusts the information collection method of the specified sensor.

For example, adjustment of the information collection method of the specified sensor includes narrowing down analysis target sensors, adjusting threshold for an associated sensor, converting feature according to the associated sensor, displaying additional information to the associated sensor, specifying cause by an inspection instruction, shortening analysis interval for the associated sensor, changing the weighting of the associated sensor, and the like.

When narrowing down analysis target sensors, the plant management apparatus 210 acquires sensor information 261 and uses it for plant management but does not use sensor information 262. In threshold adjustment for an associated sensor, the plant management apparatus 210 lowers the threshold for the sensor information 261.

Note that acquisition of position information by the terminal 220 may be done using a GPS (Global Positioning System), or in a place where GPS positioning cannot be performed, autonomous positioning like car navigation in a tunnel may be combined. In addition, the position may be acquired by analyzing an image captured by a camera.

(Functional Arrangement)

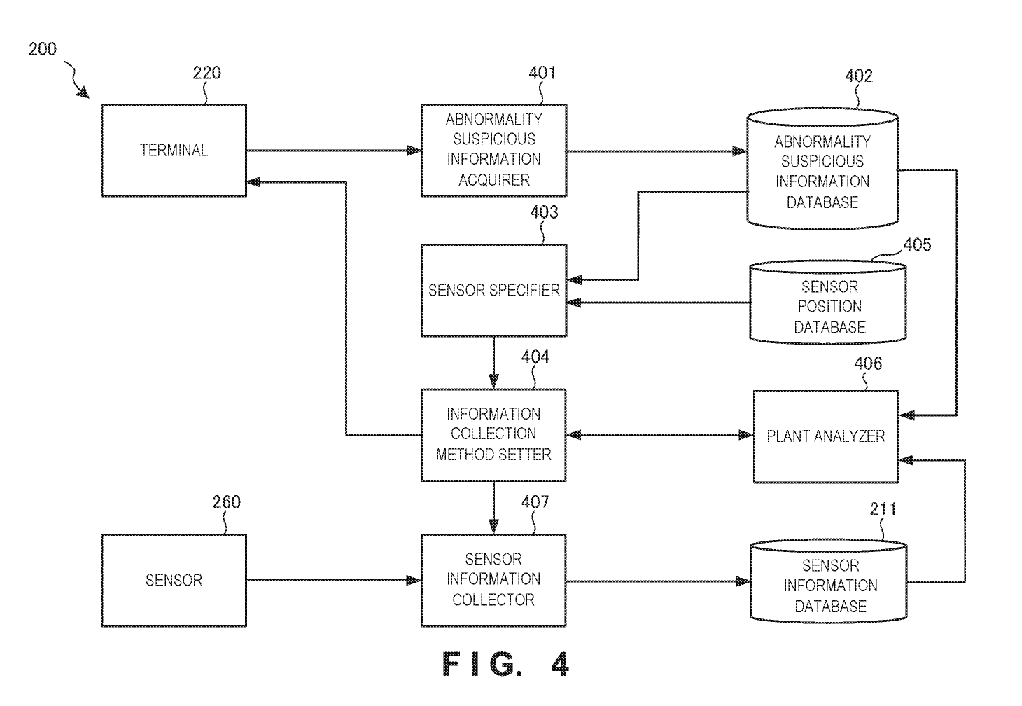

FIG. 4 is a block diagram showing the functional arrangement of the plant management system 200 according to this example embodiment. Note that the same reference numerals as in FIG. 2 denote the same constituent elements in FIG. 4, and a detailed description thereof will be omitted.

The plant management system 200 includes an abnormality suspicious information acquirer 401, an abnormality suspicious information database 402, a sensor specifier 403, an information collection method setter 404, and a sensor position database 405. The plant management system 200 also includes a plant analyzer 406 and a sensor information collector 407.

The abnormality suspicious information acquirer 401 acquires abnormality suspicious information such as a smoke, smell, or abnormal noise from the terminal 220 carried by the operator on work site together with position information and time information. The abnormality suspicious information database 402 stores the abnormality suspicious information acquired by the abnormality suspicious information acquirer 401 in association with the position information and the time information. The sensor specifier 403 specifies a sensor that is a target to variously set an information collection method based on the abnormality suspicious information obtained from the abnormality suspicious information database 402 and its occurrence position and occurrence time and the types of sensors and their installation positions obtained from the sensor position database 405. As the sensor specifying method, a method based on association with the type or occurrence position of the abnormality suspicious event is used to specify a sensor whose detection target matches the type of the abnormality suspicious event and which is located close to the occurrence position, or in a plant in which a fluid flows, specify a sensor located on the upstream side of the occurrence position of the abnormality suspicious information. Alternatively, a method based on the association between the operation time of the plant and the occurrence time of the abnormality suspicious information can also be used. Otherwise, a method of specifying a sensor by analyzing the structure of the plant or a method of obtaining the association between the abnormality suspicious information and the target to be detected by a sensor by analyzing the history of abnormality suspicious information in the past can also be used.

The information collection method setter 404 controls to variously set the information collection method for the sensor specified by the sensor specifier 403. For example, a sensor to collect sensor information is discriminated, or sensor information to be used for analysis is discriminated. The sensor position database 405 stores a sensor installed in the plant and a sensor position in association with each other. The plant analyzer 406 analyzes abnormality suspicious information accumulated in the abnormality suspicious information database 402 and sensor information accumulated in the sensor information database 211. In this example embodiment, analysis by the plant analyzer 406 changes upon application of the information collection method to the specified sensor by the information collection method setter 404. The sensor information collector 407 collects sensor information from the sensor 260. In this example embodiment, the sensor to collect sensor information changes upon application of the information collection method to the specified sensor by the information collection method setter 404. This change also influences the analysis by the plant analyzer 406 using the sensor information in the sensor information database 211.

(Hardware Arrangement)

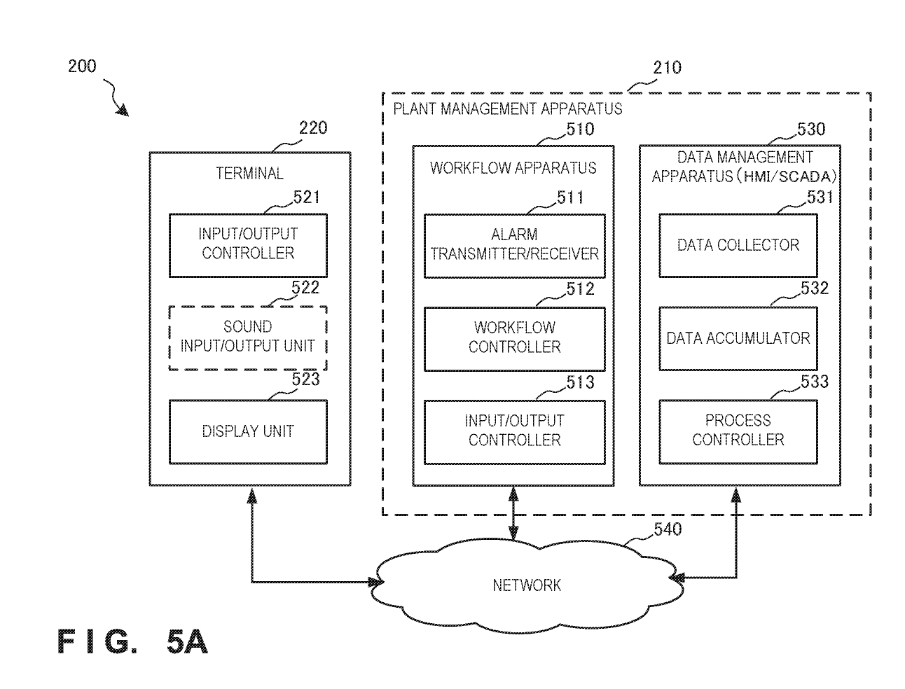

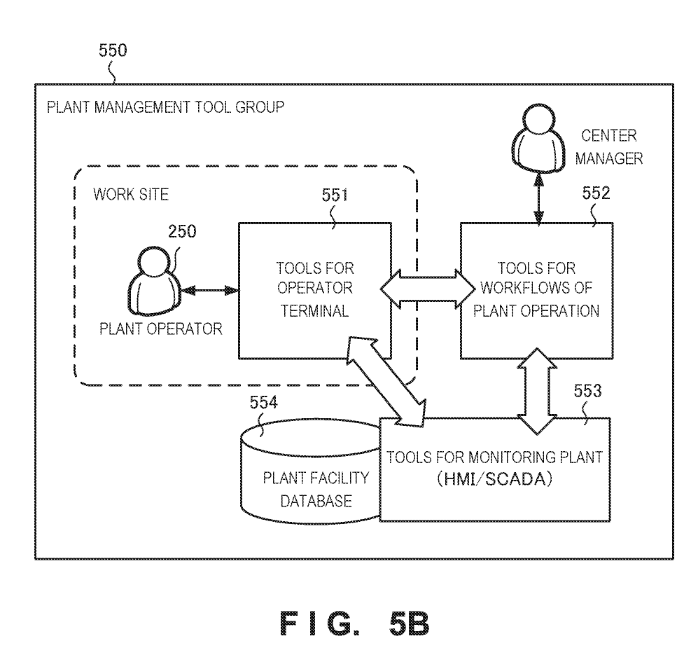

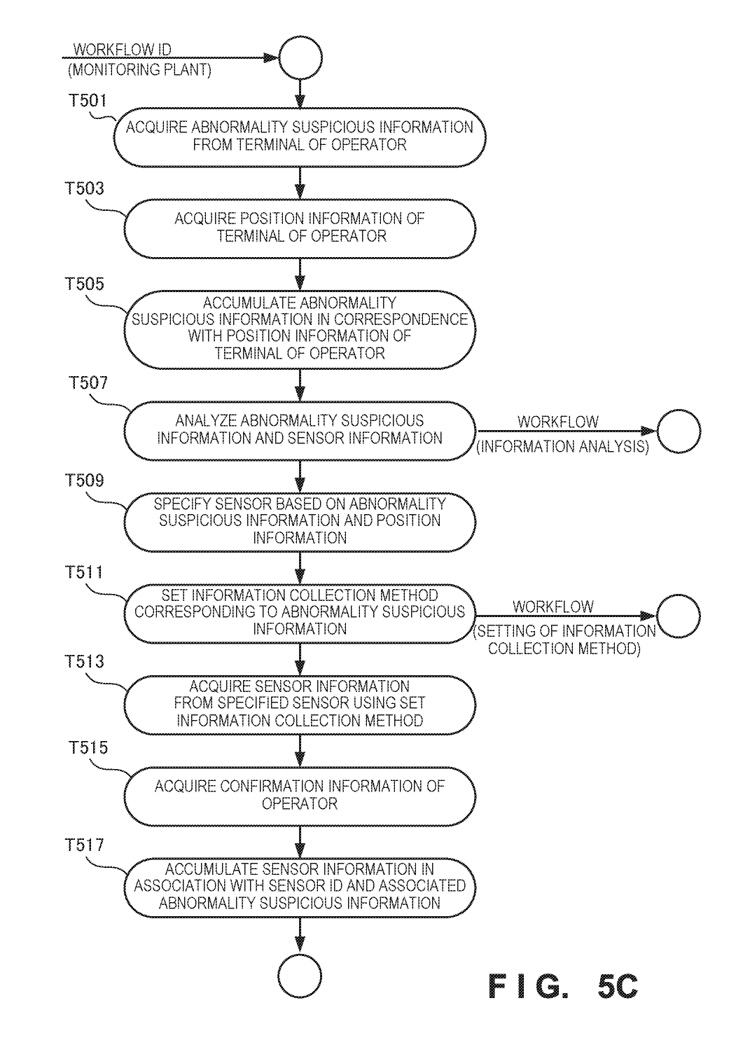

FIG. 5A is a block diagram showing the hardware arrangement of the plant management system 200 according to this example embodiment. Note that in FIG. 5A, the sensor 260 that is a main constituent element of the plant management system 200 is not illustrated to avoid complicatedness. Additionally, the same reference numerals as in FIG. 2 denote the same constituent elements in FIG. 5A. Any apparatus of the plant management system 200 is an apparatus including a processor (CPU: Central Processing Unit) and a memory. The function of each unit of the apparatus is obtained as a result of executing a program stored in the memory by the processor.

Referring to FIG. 5A, the plant management system 200 includes the plant management apparatus 210 and the terminal 220 carried by the operator 250, which are connected via a network 540. Note that the network 540 is a network formed for the entire plant or across a plurality of plants, and can be configured via the Internet using a VPN (Virtual Private Network) or the like. In addition, whether the network 540 is wired or wireless does not matter.

The plant management apparatus 210 includes a workflow apparatus 510 and a data management apparatus 530. The workflow apparatus 510 includes at least an alarm transmitter/receiver 511, a workflow controller 512, and an input/output controller 513. The alarm transmitter/receiver 511 includes a function of receiving an externally generated alarm and transmitting an alarm to the outside. The workflow controller 512 controls a workflow according to a predetermined notation or standard (for example, ISA (International Society of Automation)-95). The input/output controller 513 controls data input/output according to transmission/reception of an alarm or workflow control. The workflow apparatus 510 may further include a task list unit that displays a task list to the user and performs control concerning a work result input instruction from the user.

In addition, the data management apparatus 530 includes an HMI (Human Machine Interface) function and an SCADA (Supervisory Control And Data Acquisition) function, collects and accumulates data concerning the plant, and analyzes the accumulated data based on the interface to the management of the plant manager, thereby performing process control of the plant. The data management apparatus 530 includes at least a data collector 531, a data accumulator 532, and a process controller 533. The data collector 531 collects data detected by each sensor and data transmitted from another apparatus. The data accumulator 532 accumulates the data collected by the data collector 531 such that a search and analysis can be performed. The process controller 533 analyzes the data accumulated in the data accumulator 532 and performs process control of the plant in correspondence with the analysis result. In this example embodiment, the data collector 531 collects abnormality suspicious information, the data accumulator 532 accumulates the abnormality suspicious information, and the process controller 533 analyzes the abnormality suspicious information.

In addition, the terminal 220 carried by the operator 250 includes at least an input/output controller 521, a sound input/output unit 522, and a display unit 523. The input/output controller 521 controls input of a task list to be displayed on the display unit 523 or instruction information to the operator or input of sound data to be output from the speaker of the sound input/output unit 522 via the network 540. In addition, the input/output controller 521 controls output of current position information of the terminal 220 or abnormality suspicious information input by the operator or output of sound data collected by the microphone of the sound input/output unit 522 via the network 540. The sound input/output unit 522 includes a microphone and a speaker. The display unit 523 includes an operation unit of a touch panel, displays a task list or instruction information to the operator in association with this example embodiment, and implements operations such as input of abnormality suspicious information, information input associated with a work, a camera operation, and a recording operation. Note that transmission of position information from the terminal 220 includes both the case of an arrangement in which the position information is periodically collected by the plant management apparatus 210 and the case of an arrangement in which the position information is transmitted by the operation of the operator 250 on work site at the time of transmission of abnormality suspicious information.

Note that in this example embodiment, the characteristic functions of this example embodiment are implemented by the procedure of activating, by the workflow controller 512, a workflow for specifying a sensor in association with abnormality suspicious information based on abnormality suspicious information, sensor information, sensor position information, and the like accumulated in the data accumulator 532 and setting the information collection method. However, the present invention is not limited to this arrangement. The functions may be implemented by adding a new functional component or a new workflow for specifying a sensor in association with abnormality suspicious information based on abnormality suspicious information, sensor information, sensor position information, and the like and setting the information collection method or may be implemented by providing another dedicated apparatus.

(Software Configuration)

FIG. 5B is a block diagram showing the software configuration of the plant management system 200 according to this example embodiment. Note that FIG. 5B shows a minimum arrangement to implement the plant management system 200, and addition of another software tool, fragmentation of an illustrated software tool, overlap of a plurality of software tools, and the like are not shown.

A plant management tool group 550 shown in FIG. 5B includes at least tools 551 for operator terminal that define and manage processing associated with the terminal 220 that the operator 250 of the plant carries during an on work site work, tools 552 for workflows of plant operation associated with a plant operation by the manager in the center that manages the plant, and tools 553 for monitoring plant that collect data including sensor information and monitor the plant operation. The tools 553 analyze information in a plant facility database 554 that registers each facility forming the plant and accumulates its driving history, monitors the plant operation, and generates a maintenance operation to find or predict a failure or prevent occurrence of a failure. The tools 551 or the tools 552 generate an on work site observation maintenance operation or a center management work while referring to output information by the tools 553.

Note that in this example embodiment, by the cooperation of the tools 552, the tools 551, and the tools 553, abnormality suspicious information from the terminal 220 carried by the operator 250 on work site is accumulated, an associated sensor is specified, and an information collection method for the specified sensor is set. For example, acquisition of the abnormality suspicious information from the terminal 220 carried by the operator 250 on work site complies with the tools 551. In addition, accumulation and analysis of the abnormality suspicious information comply with the tools 553. Also, specifying of an associated sensor and setting of the information collection method for the specified sensor comply with the tools 552.

As described above, in this example embodiment, by considering the abnormality suspicious information from the operator 250 on work site, more improved observation of the operator 250 on work site or inspection information and the collected sensor information are associated with each other, and the on work site work can more effectively be incorporated in the plant management without depending on a desktop analysis result based on only collected sensor information.

(Workflow)

FIG. 5C is a view showing the workflow of the plant management system 200 according to this example embodiment. Note that FIG. 5C shows an overall workflow using all constituent elements of the plant management system 200, and the workflow is different from a work workflow corresponding to each work to be described below. In addition, the workflow of the plant management system 200 is not limited to that shown in FIG. 5C.

In the workflow of the plant management system 200 shown in FIG. 5C, in task T501, the plant management system 200 acquires abnormality suspicious information from the terminal 220 of the operator 250. In task T503, the plant management system 200 acquires the position information of the terminal 220 of the operator 250 on work site. In task T505, the plant management system 200 accumulates the abnormality suspicious information in correspondence with the position information of the terminal 220 of the operator 250.

In task T507, the plant management system 200 analyzes the abnormality suspicious information and sensor information. Note that a workflow of information analysis may be activated. In task T509, the plant management system 200 specifies a sensor based on the abnormality suspicious information and position information. Note that time information may be taken into consideration. In task T511, the plant management system 200 sets the information collection method to the specified sensor in correspondence with the abnormality suspicious information. Note that a workflow for discriminating the information collection method may be activated.

In task T513, the plant management system 200 acquires sensor information using the set information collection method from the specified sensor. In task T515, the plant management system 200 acquires confirmation information representing whether the operator 250 performs measurement in accordance with an instruction of a measurement position. In task T517, the plant management system 200 accumulates the sensor information in association with a sensor ID and associated abnormality suspicious information.

(Operation Sequence)

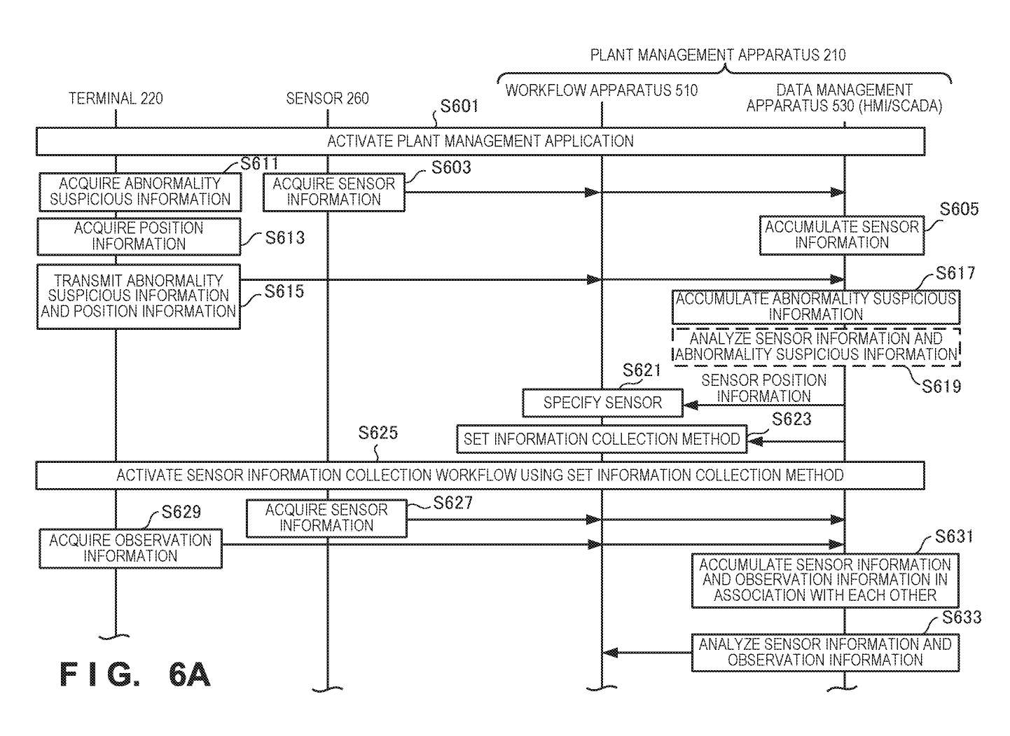

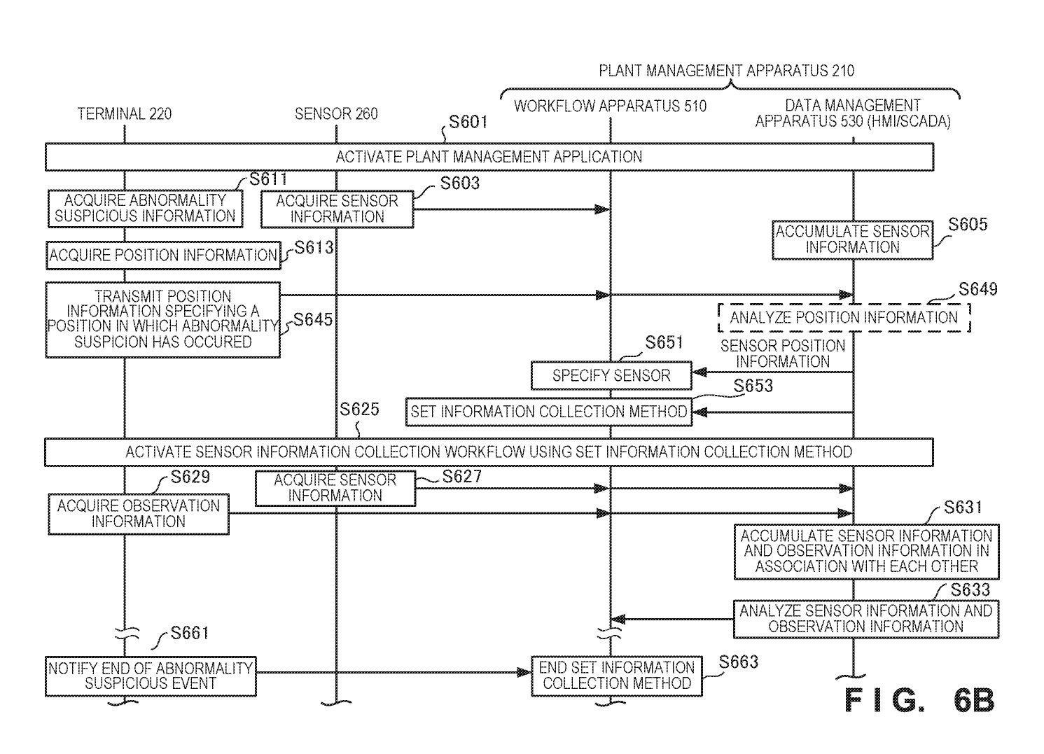

FIG. 6A is a sequence chart showing an operation procedure of the plant management system 200 according to this example embodiment. Note that the sequence chart of FIG. 6A shows only the operation procedure satisfactorily showing the feature of this example embodiment. However, the present invention is not limited to this operation procedure.

In step S601, the terminal 220, the sensor 260, and the workflow apparatus 510 and the data management apparatus 530 included in the plant management apparatus 210 activate a plant management application for each other. Note that the plant management application need not be one program and may be formed by a plurality of program tool groups. In this case, not all the constituent units need activate the plant management application simultaneously, and each unit activates the plant management application when entering the plant management system 200. For example, the terminal 220 performs login to be connected to the plant management apparatus 210, and the plant management apparatus 210 accepts the login and registers it.

In step S603, the sensor 260 acquires sensor information and transmits it to the plant management apparatus 210. In step S605, the data management apparatus 530 accumulates the acquired sensor information.

On the other hand, in step S611, if the operator 250 who carries the terminal 220 observes, for example, an abnormality such as a smell, the terminal 220 acquires abnormality suspicious information input by the operator 250. In step S613, the terminal 220 acquires current position information. Then, the terminal 220 transmits the abnormality suspicious information and the position information to the plant management apparatus 210. In step S617, the data management apparatus 530 accumulates the acquired abnormality suspicious information in association with the position information. Note that to analyze the association of the history, time information is also accumulated in association. In step S619, the data management apparatus 530 analyzes the sensor information or abnormality suspicious information.

In step S621, the workflow apparatus 510 acquires sensor position information from the data management apparatus 530 and specifies a sensor associated with the occurrence of the abnormality suspicious information based on the abnormality suspicious information and the occurrence position. Note that to specify the sensor associated with the occurrence of the abnormality suspicious information, the analysis result of the sensor information or abnormality suspicious information in step S619 may be taken into consideration. Alternatively, the occurrence time of the abnormality suspicious information may be taken into consideration. In step S623, the workflow apparatus 510 discriminates an information collection method by the specified sensor from various methods and applies the method.

In step S625, the workflow apparatus 510 activates a sensor information collection workflow using the discriminated information collection method and controls the terminal 220, the sensor 260, and the workflow apparatus 510 and the data management apparatus 530 included in the plant management apparatus 210 under the workflow. In step S627, the sensor 260 acquires sensor information and transmits it to the plant management apparatus 210 under the sensor information collection workflow. Additionally, in step S629, the terminal 220 acquires observation information by the operator 250 and transmits it to the plant management apparatus 210 under the sensor information collection workflow.

In step S631, the data management apparatus 530 accumulates the acquired sensor information and observation information in association with each other. In step S633, the data management apparatus 530 analyzes the accumulated sensor information and observation information. Then, the analysis result is notified to the workflow apparatus 510.

FIG. 6B is a sequence chart showing another operation procedure of the plant management system 200 according to this example embodiment. Note that the same step numbers as in FIG. 6A denote the same steps in FIG. 6B, and a repetitive description thereof will be omitted.

In step S645, the terminal 220 transmits position information specifying a position in which an abnormality suspicious event has occurred to the plant management apparatus 210. In the example shown in FIG. 6B, abnormality suspicious information is not transmitted as in FIG. 6A. As an option, in step S649, the data management apparatus 530 may analyze the position information. That is, sensor position information associated with the position information may be narrowed down from the history of position information in the past.

In step S651, the workflow apparatus 510 specifies an associated sensor based on the position information corresponding to the position in which the abnormality suspicious event has occurred and the sensor position information from the data management apparatus 530. That is, abnormality suspicious information associated with the abnormality suspicious event is not taken into consideration. Then, in step S653, the workflow apparatus 510 sets an information collection method associated with the specified sensor. As described above, since the abnormality suspicious information associated with the abnormality suspicious event need not be transmitted from the terminal 220 to the plant management apparatus 210, the operator 250 can specify the associated sensor and set the information collection method only by pressing a local “abnormality button”.

FIG. 6B shows the operation procedure of ending the set information collection method and returning to the normal method. Note that the same processing is performed in FIG. 6A as well. In step S661, when the operator 250 on work site observes the end of the abnormality suspicious event, the terminal 220 notifies the plant management apparatus 210 of the end of the abnormality suspicious event. The workflow apparatus 510 of the plant management apparatus 210 receives the abnormality suspicious event end notification, ends the set information collection method, and returns the processing to the original normal processing. Note that the abnormality suspicious event end notification may be received by the alarm transmitter/receiver 511 of the workflow apparatus 510 as one of alarms and notified to the workflow controller 512.

<<Data Accumulator of Data Management Apparatus>>

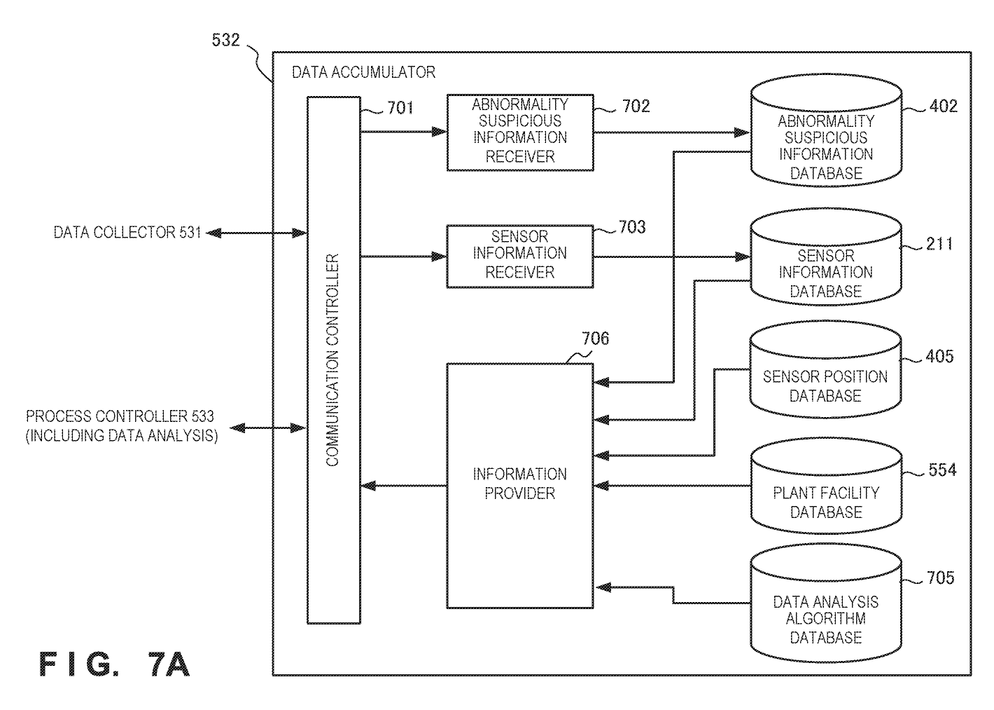

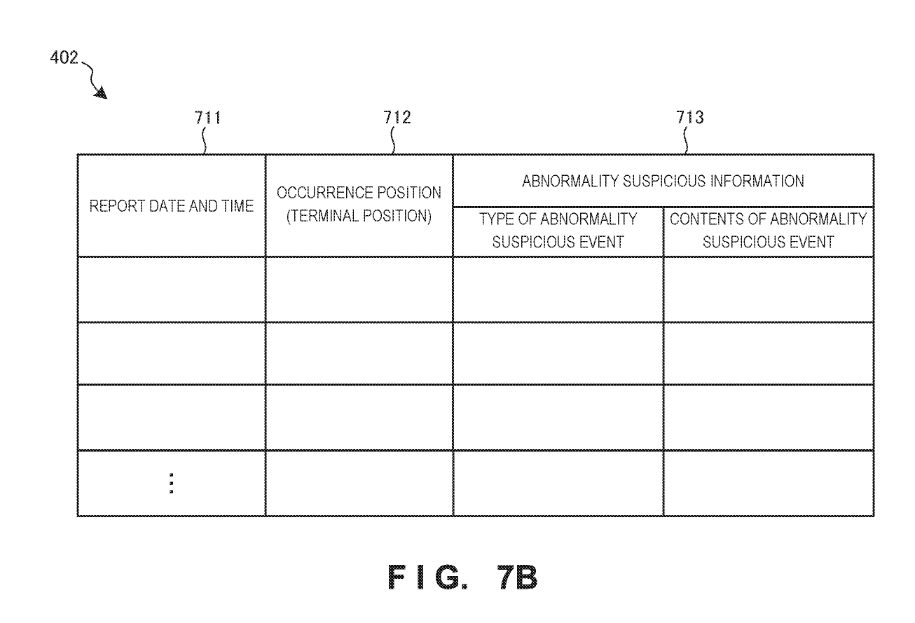

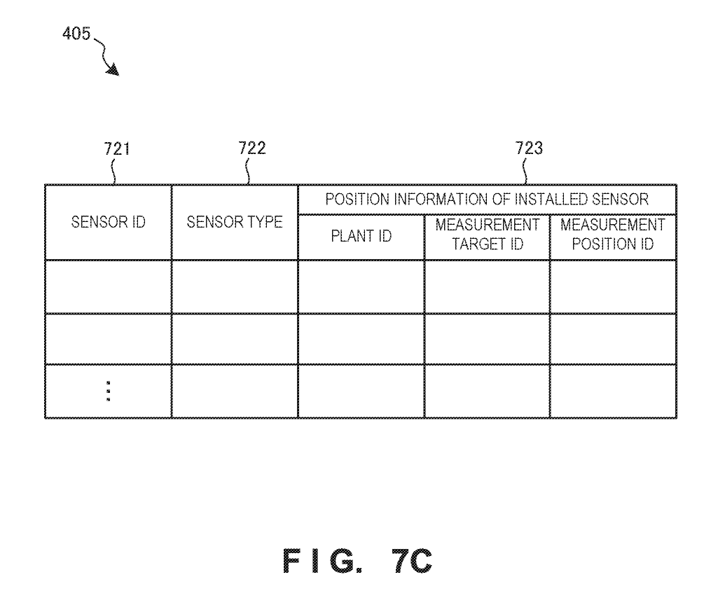

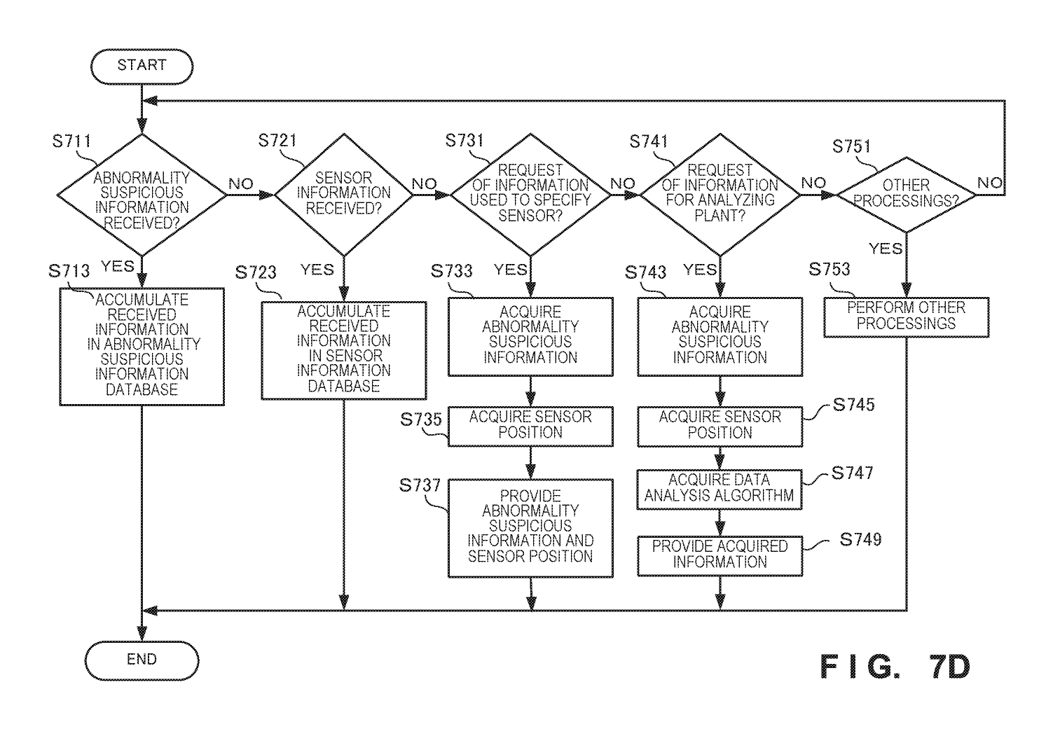

FIG. 7A is a block diagram showing the functional arrangement of the data accumulator 532 according to this example embodiment. The data accumulator 532 is provided in the data management apparatus 530 and accumulates data collected by the data collector 531. In this example embodiment, abnormality suspicious information notified by the operator 250 from the terminal 220 is accumulated in the abnormality suspicious information database 402, and sensor information detected by a sensor is accumulated in the sensor information database 211. The data accumulator 532 also includes the sensor position database 405 that accumulates a sensor position. Note that the same reference numerals as in FIG. 2 or 4 denote the same functional components in FIG. 7A, and a repetitive description thereof will be omitted.

The data accumulator 532 includes a communication controller 701, an abnormality suspicious information receiver 702, a sensor information receiver 703, the plant facility database 554, a data analysis algorithm database 705, and an information provider 706.

The communication controller 701 controls communication between the data collector 531 and the process controller 533 in the same data management apparatus 530. The abnormality suspicious information receiver 702 receives abnormality suspicious information notified by the operator 250 from the terminal 220 and sends it to the abnormality suspicious information database 402. The sensor information receiver 703 receives sensor information detected by a sensor and sends it to the sensor information database 211. The plant facility database 554 stores facility information of the plant as the management target. The data analysis algorithm database 705 stores an algorithm configured to analyze the abnormality suspicious information accumulated in the abnormality suspicious information database 402 or the sensor information accumulated in the sensor information database 211. The information provider 706 acquires data necessary for processing from each database and provides the data.

(Abnormality Suspicious Information Database)

FIG. 7B is a view showing the arrangement of the abnormality suspicious information database 402 according to this example embodiment. The abnormality suspicious information database 402 stores abnormality suspicious information notified by the operator 250 from the terminal 220.

The abnormality suspicious information database 402 accumulates a report date/time 711 at which abnormality suspicious information is reported, an occurrence position 712 of the abnormality suspicious information, which is the position of the terminal, and abnormality suspicious information 730 in association with each other. The abnormality suspicious information 730 includes the type of an abnormality suspicious event such as a smell or sound, and the contents of the abnormality suspicious event such as a type of smell or a type of sound.

Here, as the type of the abnormality suspicious event, there exist middle concepts such as a degree of danger, a degree of importance, and an abnormality content type and subordinate concepts included in each of the middle concepts. For example, subordinate concepts included in the degree of danger or the degree of importance as the middle concept include types such as an influence on human life, possibility of leading to an accident, safe (simple information providing), shutdown, and possibility of leading to shutdown. In addition, subordinate concepts included in the abnormality content type include types such as presence of a smell, presence of abnormal noise, presence of a vibration, screw falling, light emission, liquid leakage, smoke emission, and fogging. In addition, the contents of an abnormality suspicious event indicate more detailed abnormality contents such as “smell of acid”, “creaking noise”, “shining pipe surface”, and “liquid on the floor”.

(Sensor Position Database)

FIG. 7C is a view showing the arrangement of the sensor position database 405 according to this example embodiment. The sensor position database 405 stores the position of each sensor installed in the plant.

The sensor position database 405 stores a sensor ID 721, a sensor type 722, and position information 723 of installed sensor in association with each other. The position information 723 includes a plant ID, a measurement target ID as a part of the plant, and a measurement position ID in the measurement target.

<<Operation Procedure of Data Accumulator>>

FIG. 7D is a flowchart showing the operation procedure of the data accumulator 532 according to this example embodiment. The processor that controls the data management apparatus 530 or the data accumulator 532 executes this flowchart using the memory to implement the functional components shown in FIG. 7A. The following explanation will be made assuming that the processor of the data management apparatus 530 executes the flowchart.

In step S711, the data management apparatus 530 determines whether abnormality suspicious information is received. Upon receiving abnormality suspicious information, in step S713, the data management apparatus 530 accumulates the received abnormality suspicious information in the abnormality suspicious information database 402.

If abnormality suspicious information is not received, in step S721, the data management apparatus 530 determines whether sensor information is received. Upon receiving sensor information, in step S723, the data management apparatus 530 accumulates the received sensor information in the sensor information database 211.

If abnormality suspicious information is not received, and sensor information is not received, in step S731, the data management apparatus 530 determines whether it is a request of information used to specify a sensor associated with abnormality suspicious information. If it is a request of information used to specify a sensor, in step S733, the data management apparatus 530 acquires abnormality suspicious information from the abnormality suspicious information database 402. Additionally, in step S735, the data management apparatus 530 acquires a sensor position from the sensor position database 405. Then, in step S737, the data management apparatus 530 provides the abnormality suspicious information including position information and the sensor position to the request destination.

If abnormality suspicious information is not received, sensor information is not received, and it is not specifying of a sensor, in step S741, the data management apparatus 530 determines whether it is a request of information used for analyzing plant. If it is a request of information used for plant analysis, in step S743, the data management apparatus 530 acquires abnormality suspicious information from the abnormality suspicious information database 402. Additionally, in step S745, the data management apparatus 530 acquires a sensor position from the sensor position database 405. In addition, in step S747, the data management apparatus 530 acquires a corresponding data analysis algorithm from the data analysis algorithm database 705. Then, in step S749, the data management apparatus 530 provides the acquired information to the request source.

If abnormality suspicious information is not received, sensor information is not received, it is neither specifying of a sensor nor plant analysis, in step S751, the data management apparatus 530 determines whether it is another processing or not. If it is another processing, in step S753, the data management apparatus 530 performs the other processing.

<<Workflow Controller of Workflow Apparatus>>

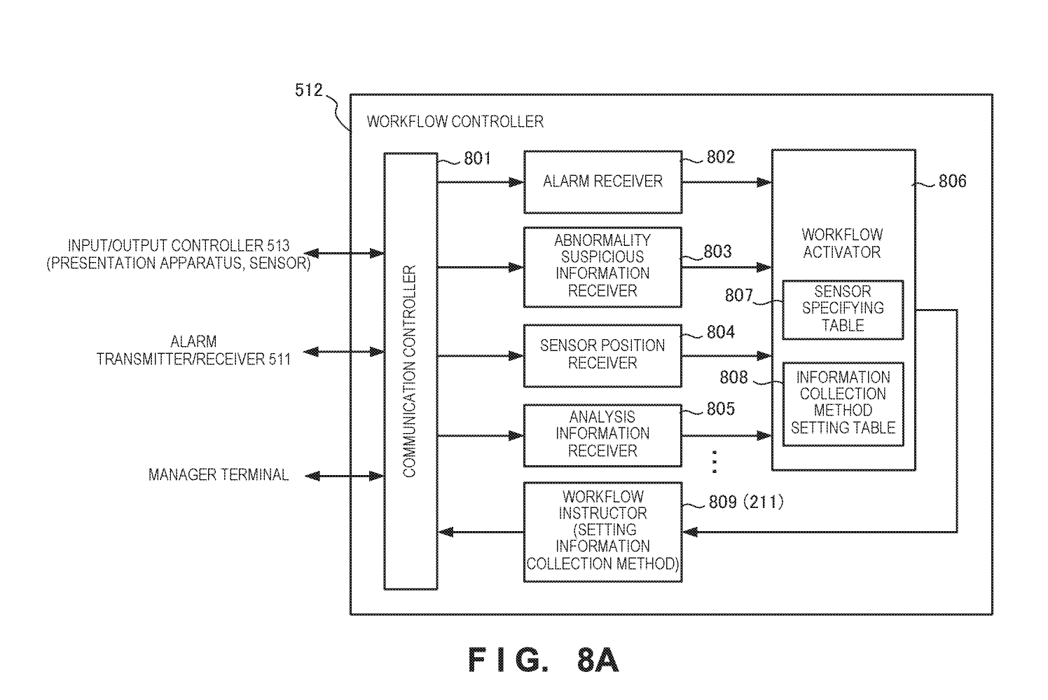

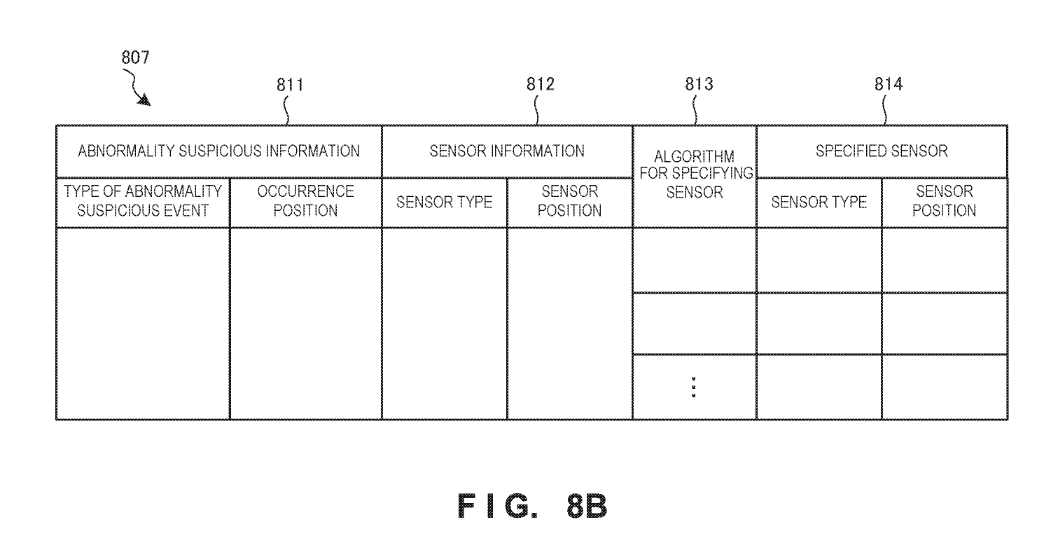

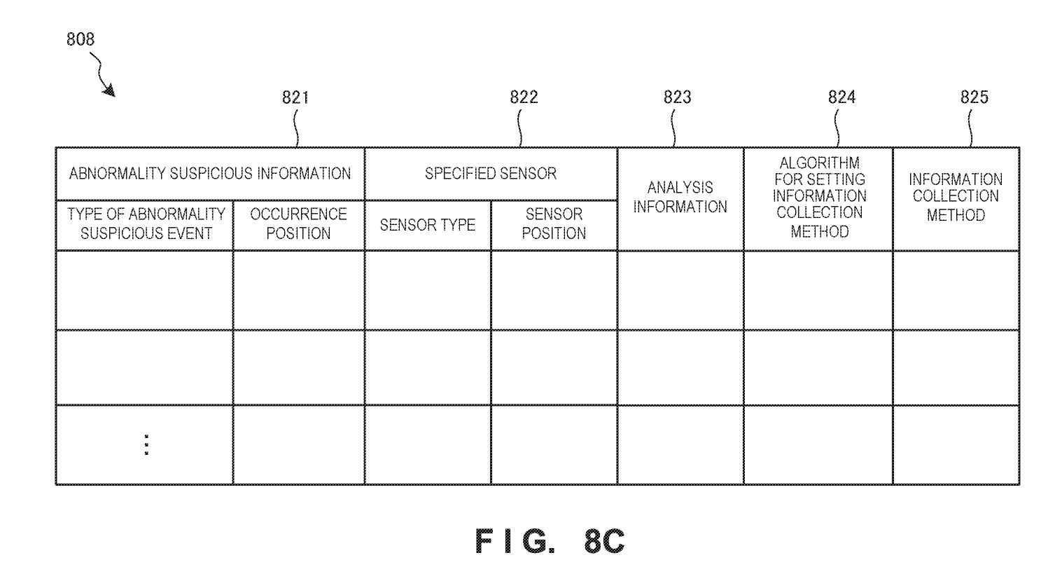

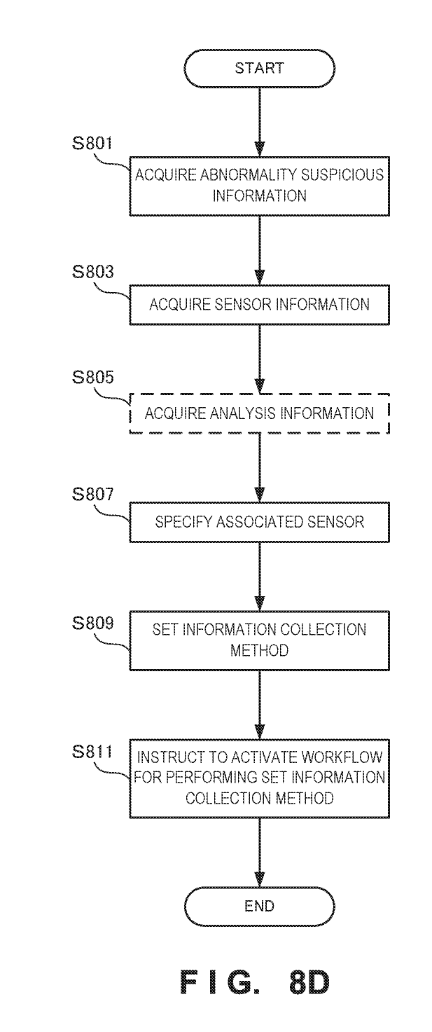

FIG. 8A is a block diagram showing the functional arrangement of the workflow controller 512 according to this example embodiment. The workflow controller 512 controls a workflow according to a predetermined notation or standard, for example, ISA-95. In this example embodiment, upon receiving abnormality suspicious information from the terminal 220, the workflow controller 512 specifies an associated sensor based on the position information of the terminal 220, and activates a workflow for collecting information by a method discriminated from various information collection methods.

The workflow controller 512 includes a communication controller 801, an alarm receiver 802, an abnormality suspicious information receiver 803, a sensor position receiver 804, an analysis information receiver 805, and a workflow activator 806. The workflow activator 806 includes a sensor specifying table 807 and an information collection method setting table 808. In addition, the workflow controller 512 further includes a workflow instructor 809. An instruction by the workflow instructor 809 implements the processing of the sensor specifier 403 or the information collection method setter 404.

(Sensor Specifying Table)

FIG. 8B is a view showing the arrangement of the sensor specifying table 807 according to this example embodiment. The sensor specifying table 807 is used to specify a sensor associated with abnormality suspicious information.

The sensor specifying table 807 specifies a specified sensor 814 in accordance with an algorithm for specifying sensor 813 based on abnormality suspicious information 811 and sensor information 812. The algorithm for specifying sensor 813 includes an algorithm for specifying a sensor based on the association between a sensor position and the occurrence position of abnormality suspicious information, the flow in the plant (upstream or downstream), the occurrence time, and the like.

(Information Collection Method Setting Table)

FIG. 8C is a view showing the arrangement of the information collection method setting table 808 according to this example embodiment. The information collection method setting table 808 is used to set an information collection method for a sensor specified in association with abnormality suspicious information.

In the information collection method setting table 808, an information collection method 825 is set in accordance with an algorithm for setting information collection method 824 using abnormality suspicious information 821, a specified sensor 822, and if necessary, analysis information 823. The algorithm for setting information collection method 824 includes discrimination of an information collection method based on whether to limit information collection to the specified sensor, whether to place importance on the specified sensor, a change of involvement in analysis, or the like.

<<Operation Procedure of Workflow Controller>>

FIG. 8D is a flowchart showing the operation procedure of the workflow controller 512 according to this example embodiment. The processor of the workflow apparatus 510 or the workflow controller 512 executes this flowchart using the memory to implement the functional components shown in FIG. 8A. The following explanation will be made assuming that the processor of the workflow apparatus 510 executes the flowchart.

In step S801, the workflow apparatus 510 acquires abnormality suspicious information from the abnormality suspicious information database 402 of the data accumulator 532. In step S803, the workflow apparatus 510 acquires a sensor position from the sensor position database 405 of the data accumulator 532. If necessary, in step S805, the workflow apparatus 510 acquires analysis information.

In step S807, the workflow apparatus 510 specifies a sensor associated with the abnormality suspicious information using the sensor specifying table 807. Note that when specifying the sensor, an abnormality occurrence time and the like may be taken into consideration. In step S809, the workflow apparatus 510 sets an information collection method using the information collection method setting table 808 in accordance with the abnormality suspicious information and the specified sensor. Note that when setting the information collection method, the sensor position, the abnormality occurrence time, and the like may be taken into consideration.

In step S811, the workflow apparatus 510 instructs to activate the workflow for performing the set information collection method.

<<Work Workflow>>

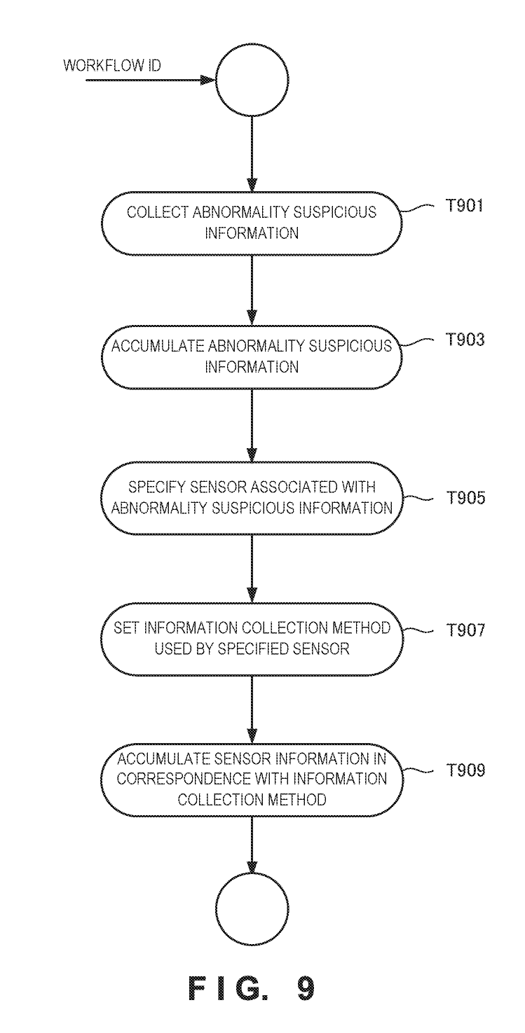

FIG. 9 is a view showing the workflow of a work in the plant management system 200 according to this example embodiment. Note that the workflow shown in FIG. 9 is a new workflow that describes a processing portion configured to specify a sensor based on abnormality suspicious information from the terminal on work site and set an information collection method in this example embodiment. The workflow to be described below indicates a work procedure executed by the workflow apparatus 510 using the constituent apparatuses or functional components of the plant management system. Note that FIG. 9 shows only minimum basic tasks of this example embodiment, and various tasks may be added.

In task T901, the workflow apparatus 510 collects abnormality suspicious information from the terminal 220 of the operator 250 on work site. In task T903, the workflow apparatus 510 accumulates the collected abnormality suspicious information. In task T905, the workflow apparatus 510 specifies a sensor associated with the abnormality suspicious information. In task T907, the workflow apparatus 510 sets an information collection method used by the specified sensor. In task T909, the workflow apparatus 510 collects sensor information nu the set information collection method and accumulates the sensor information. Note that the information collection method according to this example embodiment is used as a method including not only information collection but also a use method of the collected information.

<<Setting Examples of Information Collection Method of Sensor>>

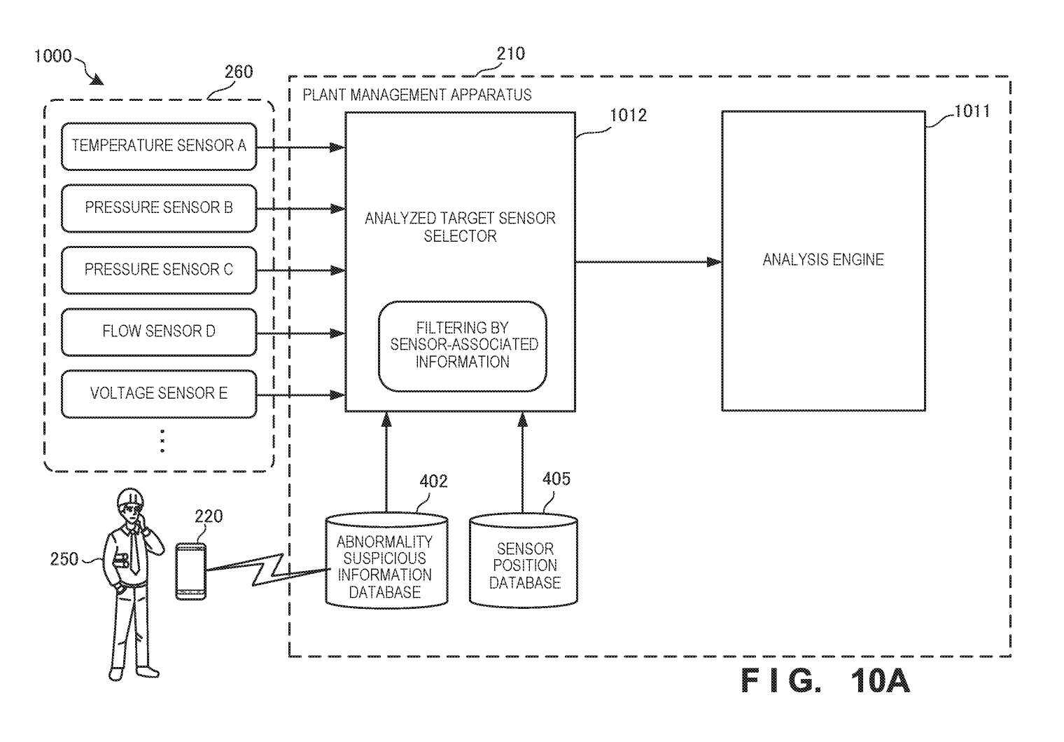

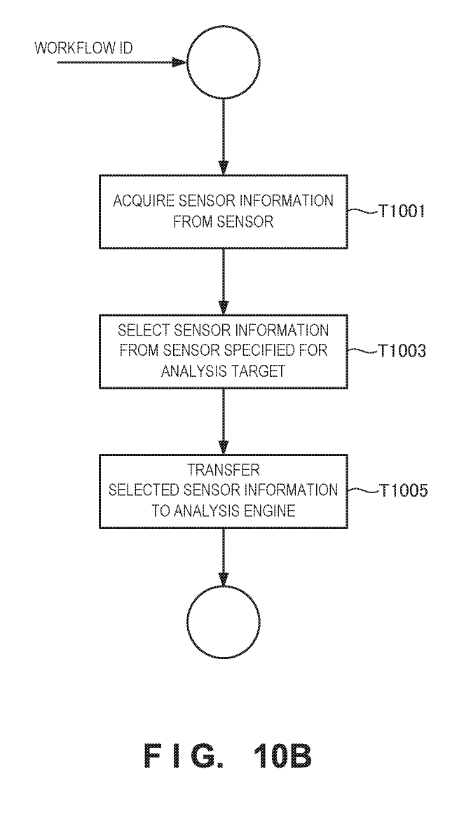

Examples in which the information collection method of the specified sensor is discriminated and set will be described with reference to FIGS. 10A to 17B. Note that the same reference numerals as in FIG. 2 or 4 denote the same constituent elements in FIGS. 10A to 17B, and a repetitive description thereof will be omitted.

(Discrimination of Data Collection)

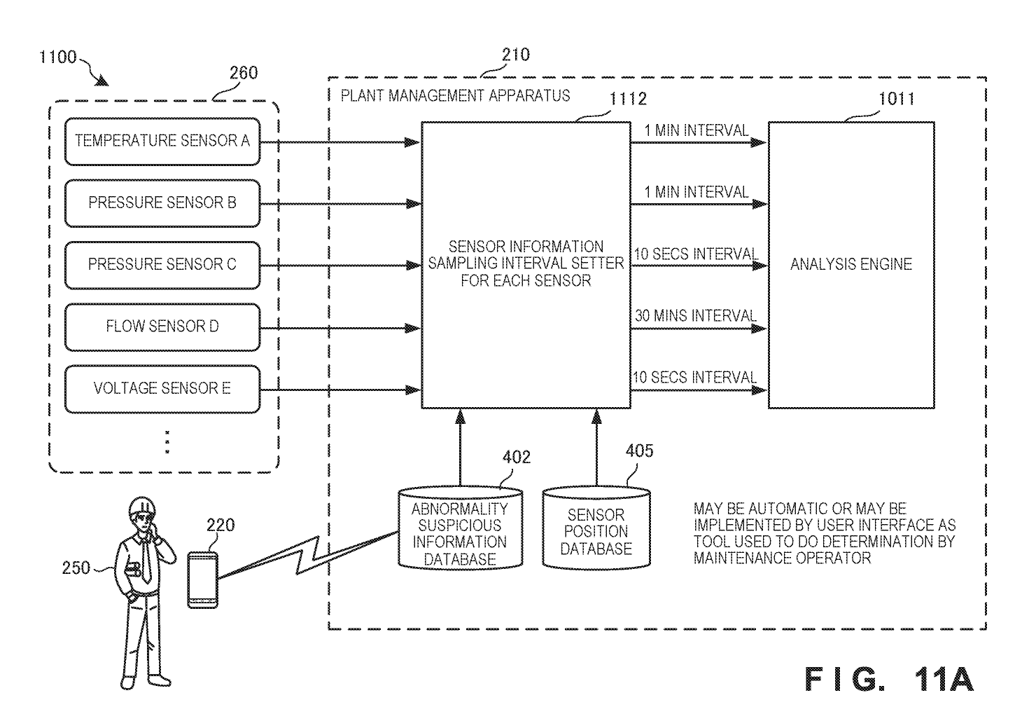

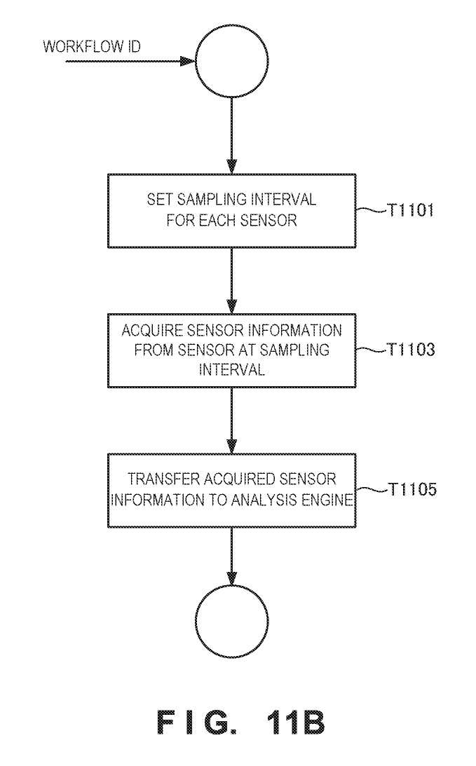

Examples in which data collection from a sensor is discriminated will be described first with reference to FIGS. 10A to 11B. In the examples, an information collection method of discriminating data input from a specified sensor from data input from another sensor is set. Note that the method of discriminating data collection from the sensors is not limited to the following examples.

In the first information collection method shown in FIGS. 10A and 10B, an information collection method of limiting data input to a specified sensor is set.

FIG. 10A is a view showing an arrangement for implementing the first information collection method in the plant management system 200 according to this example embodiment. Note that the same reference numerals as in FIGS. 2 and 4 denote the same constituent elements in FIG. 10A, and a repetitive description thereof will be omitted.

In a plant management system 1000 shown in FIG. 10A, the plant management apparatus 210 includes an analysis engine 1011 and an analyzed target sensor selector 1012. The analysis engine 1011 analyzes sensor information from a sensor. The analyzed target sensor selector 1012 performs filtering based on abnormality suspicious information accumulated in the abnormality suspicious information database 402 and a sensor position accumulated in the sensor position database 405 to select transmission of sensor information from the input from the sensor 260 to the analysis engine 1011 to a sensor specified based on sensor-associated information.

For example, the sensors are narrowed down to only sensors associated with a pressure sensor C and a voltage sensor E on the periphery of an abnormality-registered point. That is, input to the analysis engine 1011 is limited to only the sensor C and invariants including the sensor C, or invariants associated with sensor groups associated with the upstream and downstream of the sensors C and E.

FIG. 10B is a view showing a workflow for implementing the first information collection method according to this example embodiment.

In task T1001, the workflow controller 512 acquires sensor information from sensors. In task T1003, the workflow controller 512 selects sensor information from a sensor specified for an analysis target. In task T1005, the workflow controller 512 transfers the selected sensor information to the analysis engine 1011.

In the second information collection method shown in FIGS. 11A and 11B, an information collection method of changing the interval of data input of a specified sensor is set.

FIG. 11A is a view showing an arrangement for implementing the second information collection method in the plant management system 200 according to this example embodiment. Note that the same reference numerals as in FIGS. 2, 4, and 10A denote the same constituent elements in FIG. 11A, and a repetitive description thereof will be omitted.

In a plant management system 1100 shown in FIG. 11A, the plant management apparatus 210 includes a sensor information sampling interval setter 1112 for each sensor. The sensor information sampling interval setter 1112 for each sensor performs adjustment to shorten the sampling interval of sensor information from a specified sensor associated with abnormality suspicious information, thereby sending a large quantity of sensor information from the specified sensor to the analysis engine 1011 and enhancing involvement of the sensor information from the specified sensor in the analysis.

For example, the sampling interval of the pressure sensor C and the voltage sensor E associated with abnormality suspicious information is 10 secs, and the sampling interval of a less associated flow sensor D is 30 mins.

FIG. 11B is a view showing a workflow for implementing the second information collection method according to this example embodiment.

In task T1101, the workflow controller 512 sets a sampling interval for each sensor. At this time, the sampling interval of a specified sensor associated with abnormality suspicious information is set to be shorter than usual. In task T1103, the workflow controller 512 acquires sensor information from the sensor at the set sampling interval. In task T1105, the workflow controller 512 transfers the sensor information acquired at the set sampling interval to the analysis engine 1011.

Note that execution of the second information collection method may be automatic or may be implemented by a UI (user interface) as a tool used to do determination by a maintenance operator.

(Discrimination of Data Analysis)

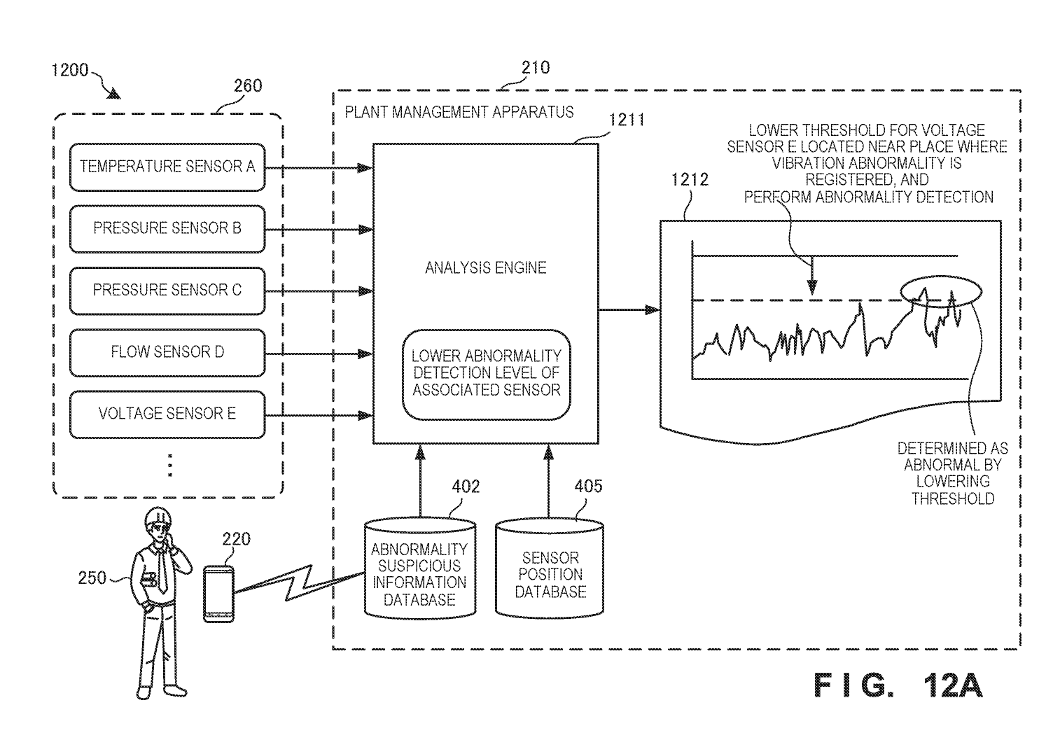

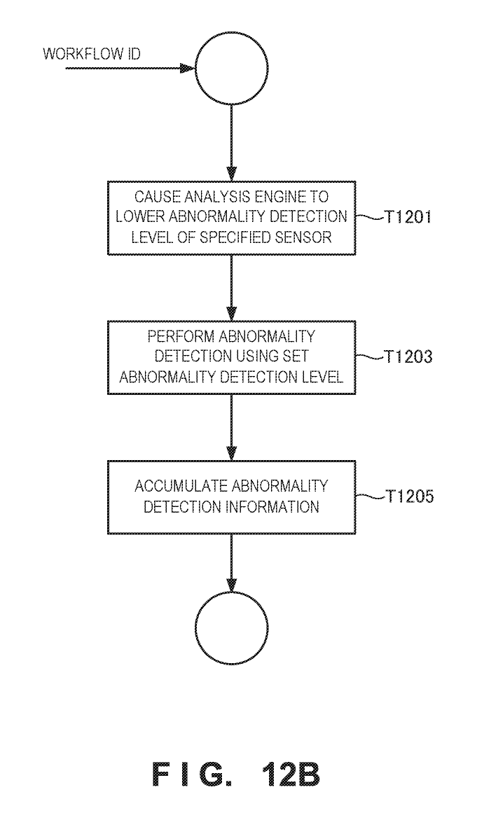

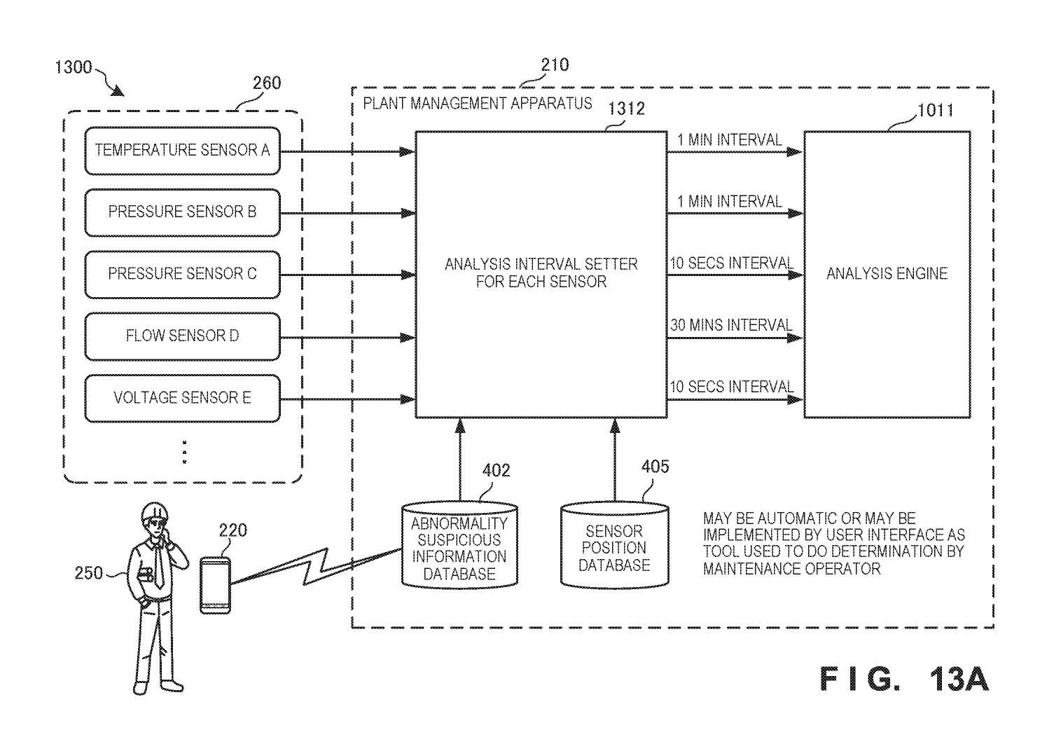

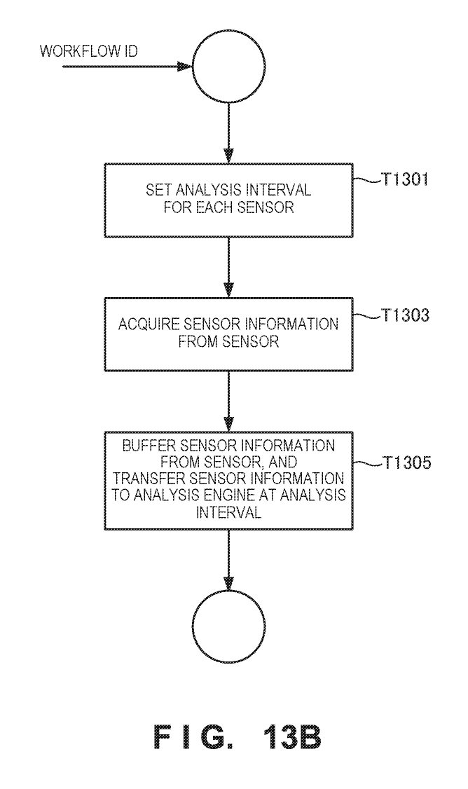

Examples in which discrimination is performed in data analysis will be described next with reference to FIGS. 12A to 13B. In the examples, an information collection method of discriminating analysis of data from a specified sensor from analysis of data from another sensor is set. Note that the method of performing discrimination in data analysis is not limited to the following examples.

In the third information collection method shown in FIGS. 12A and 12B, an information collection method of changing a threshold for abnormality detection of a specified sensor is set.

FIG. 12A is a view showing an arrangement for implementing the third information collection method in the plant management system 200 according to this example embodiment. Note that the same reference numerals as in FIGS. 2 and 4 denote the same constituent elements in FIG. 12A, and a repetitive description thereof will be omitted.

In a plant management system 1200 shown in FIG. 12A, the plant management apparatus 210 includes an analysis engine 1211 that lowers the abnormality detection level of a specified sensor associated with abnormality suspicious information. The analysis engine 1211 lowers the threshold for the voltage sensor E located near the place where a vibration abnormality is registered to facilitate determination of abnormality detection, as indicated by, for example, a graph 1212.

FIG. 12B is a view showing a workflow for implementing the third information collection method according to this example embodiment.

In task T1201, the workflow controller 512 causes the analysis engine 1211 to lower the abnormality detection level of the specified sensor associated with abnormality suspicious information to raise the sensitivity of abnormality detection. In task T1203, the workflow controller 512 performs abnormality detection using the set abnormality detection level. In task T1205, the workflow controller 512 accumulates the abnormality detection information.

In the fourth information collection method shown in FIGS. 13A and 13B, an information collection method of changing the analysis interval of analysis of data of a specified sensor is set.

FIG. 13A is a view showing an arrangement for implementing the fourth information collection method in the plant management system 200 according to this example embodiment. Note that the same reference numerals as in FIGS. 2, 4, and 10A denote the same constituent elements in FIG. 13A, and a repetitive description thereof will be omitted.

In a plant management system 1300 shown in FIG. 13A, the plant management apparatus 210 includes an analysis interval setter 1312 for each sensor. The analysis interval setter 1312 for each sensor performs adjustment to shorten the analysis interval of the analysis engine 1011 using sensor information from a specified sensor associated with abnormality suspicious information, thereby making the sensor information from the specified sensor more involved in the analysis by the analysis engine 1011.

FIG. 13B is a view showing a workflow for implementing the fourth information collection method according to this example embodiment.

In task T1301, the workflow controller 512 sets an analysis interval for each sensor. At this time, the analysis interval of a specified sensor associated with abnormality suspicious information is set to be shorter than usual. In task T1303, the workflow controller 512 acquires sensor information from the sensor at the sampling interval. In task T1305, the workflow controller 512 buffers the sensor information from the sensor and transfers the sensor information to the analysis engine 1011 at the set analysis interval.

Note that execution of the fourth information collection method may be automatic or may be implemented in a UI as a tool used to do determination by a maintenance operator.

(Discrimination of Sensor Display)

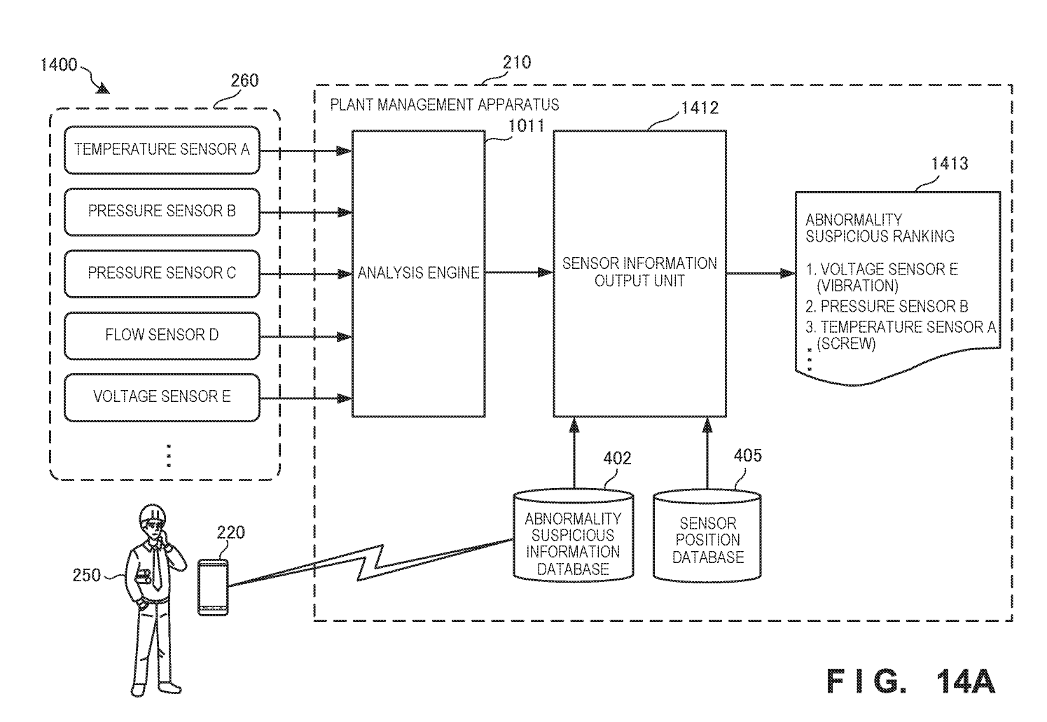

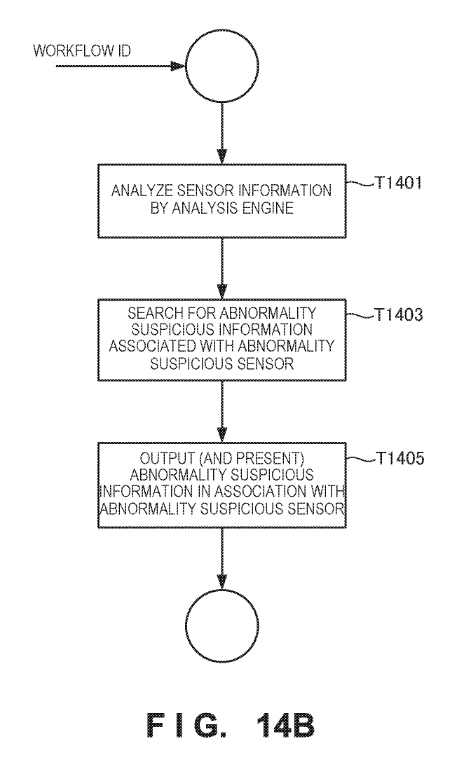

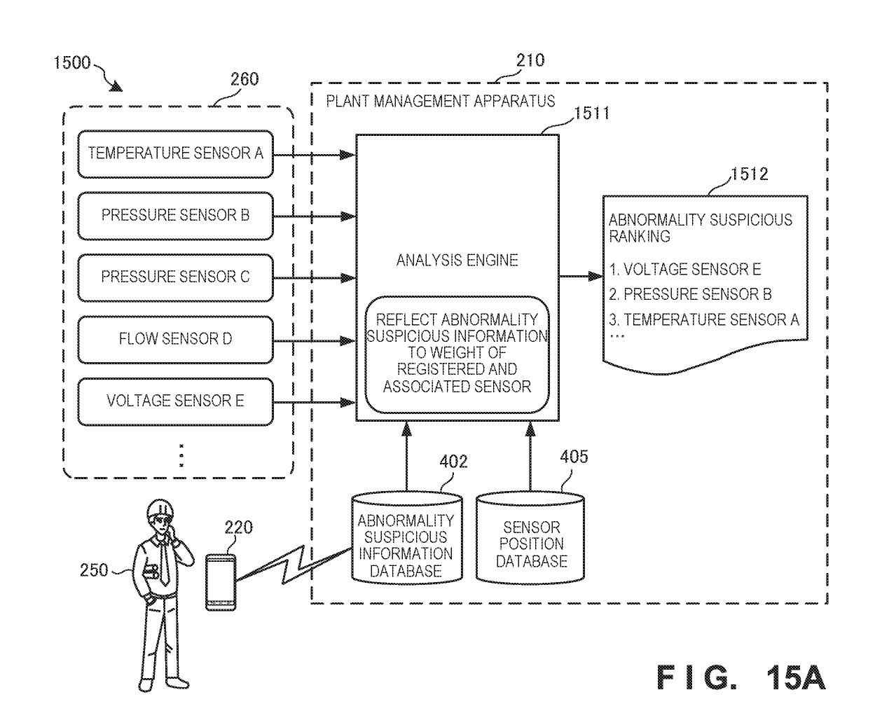

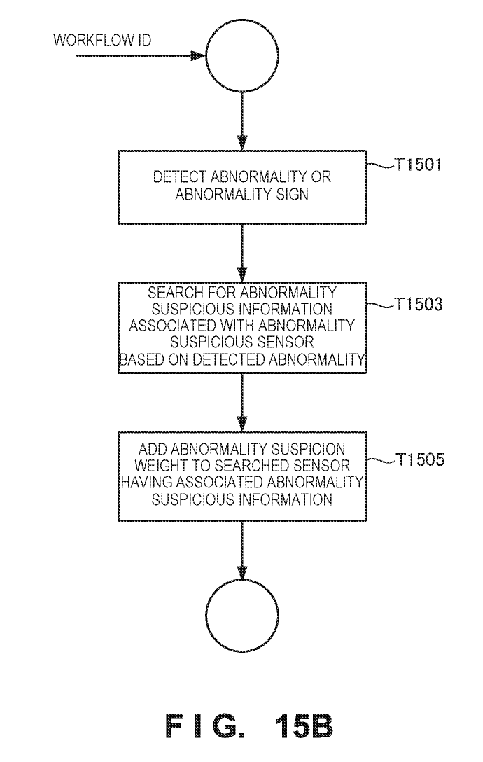

Examples in which discrimination is performed in abnormality suspicious sensor display will be described next with reference to FIGS. 14A to 15B. In the examples, an information collection method of discriminating display of a specified sensor is set. Note that the method of performing discrimination in abnormality suspicious sensor display is not limited to the following examples.

In the fifth information collection method shown in FIGS. 14A and 14B, an information collection method of adding the information of an abnormality suspicious event to a specified sensor in abnormality suspicious sensor ranking display is set.

FIG. 14A is a view showing an arrangement for implementing the fifth information collection method in the plant management system 200 according to this example embodiment. Note that the same reference numerals as in FIGS. 2 and 4 denote the same constituent elements in FIG. 14A, and a repetitive description thereof will be omitted.

In a plant management system 1400 shown in FIG. 14A, the plant management apparatus 210 includes a sensor information output unit 1412. The sensor information output unit 1412 outputs an abnormality suspicious ranking 1413 by referring to the abnormality suspicious information database 402 and adding associated abnormality suspicious information to the abnormality suspicious ranking of a sensor generated based on the analysis result of the analysis engine 1011. Here, the associated abnormality suspicious information includes not only association with the occurrence position of abnormality suspicious information but also association by the type of an abnormality suspicious event, association considering the operation state of the plant, and the like.

For example, in the abnormality suspicious ranking 1413, the occurrence of a vibration abnormality is output in association with the voltage sensor E of the top ranking, and drop of a screw is output in association with a temperature sensor A of the third ranking. The operator 250 on work site or the plant manager can improve plant abnormality prevention by referring to these pieces of abnormality suspicious information.

FIG. 14B is a view showing a workflow for implementing the fifth information collection method according to this example embodiment.

In task T1401, the workflow controller 512 causes the analysis engine 1011 to analyze sensor information and generate the abnormality suspicious ranking of sensor. In task T1403, the workflow controller 512 searches the abnormality suspicious information database 402 for associated abnormality suspicious information concerning an abnormality suspicious sensor of a high abnormality suspicious ranking. In task T1405, the workflow controller 512 outputs found abnormality suspicious information in association with the associated sensor and presents it to the operator 250 on work site or the plant manager.

In the sixth information collection method shown in FIGS. 15A and 15B, an information collection method of changing the order of a specified sensor in the ranking display of abnormality suspicious sensors is set.

FIG. 15A is a view showing an arrangement for implementing the sixth information collection method in the plant management system 200 according to this example embodiment. Note that the same reference numerals as in FIGS. 2 and 4 denote the same constituent elements in FIG. 15A, and a repetitive description thereof will be omitted.

In a plant management system 1500 shown in FIG. 15A, the plant management apparatus 210 includes an analysis engine 1511 that weights a specified sensor associated with registered abnormality suspicious information and reflects it on the abnormality suspicious ranking of the sensor. For example, when information representing that abnormality suspicious information is generated near the voltage sensor E is received, the analysis engine 1511 adds a weight to the voltage sensor E in accordance with the degree of association with the abnormality suspicious information. In FIG. 15A, as the analysis result of the analysis engine 1511 considering the weight, an abnormality suspicious ranking 1512 including the voltage sensor E at the top is output and presented to the operator 250 on work site or the plant manager.

For example, since “smell abnormality” or “vibration” is registered near the voltage sensor E, the weight of the sensor E is doubled. Alternately, since the registration time of “smell abnormality” near the voltage sensor E is earlier than the abnormality registration times on the periphery of other sensors, the weight of the sensor E is doubled. As a result, in the abnormality suspicious ranking 1512, the voltage sensor E is ranked at the top.

FIG. 15B is a view showing a workflow for implementing the sixth information collection method according to this example embodiment.

In task T1501, the workflow controller 512 causes the analysis engine 1011 to analyze sensor information or abnormality suspicious information and detects an abnormality or an abnormality sign in the plant or sensor. In task T1503, the workflow controller 512 searches the abnormality suspicious information database 402 for abnormality suspicious information associated with an abnormality suspicious sensor based on the detected abnormality. In task T1505, the workflow controller 512 adds an abnormality suspicion weight to the searched sensor for which the associated abnormality suspicious information is found to set the searched sensor at a high abnormality suspicious ranking and presents it to the operator 250 on work site or the plant manager.

(Observation Instruction)

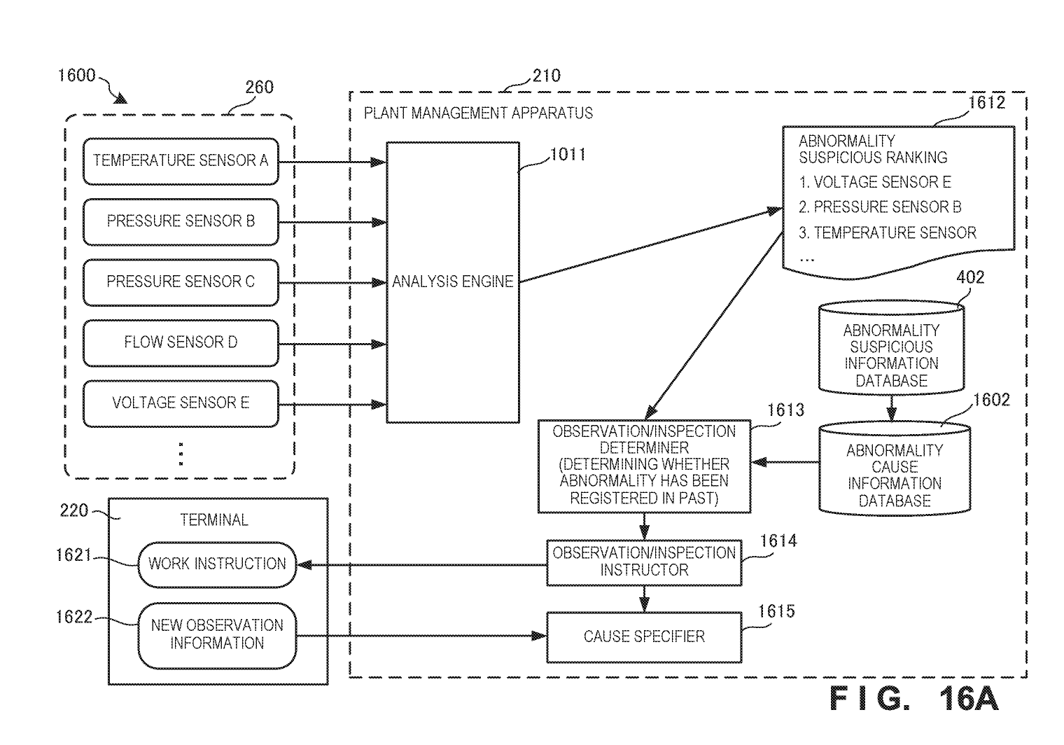

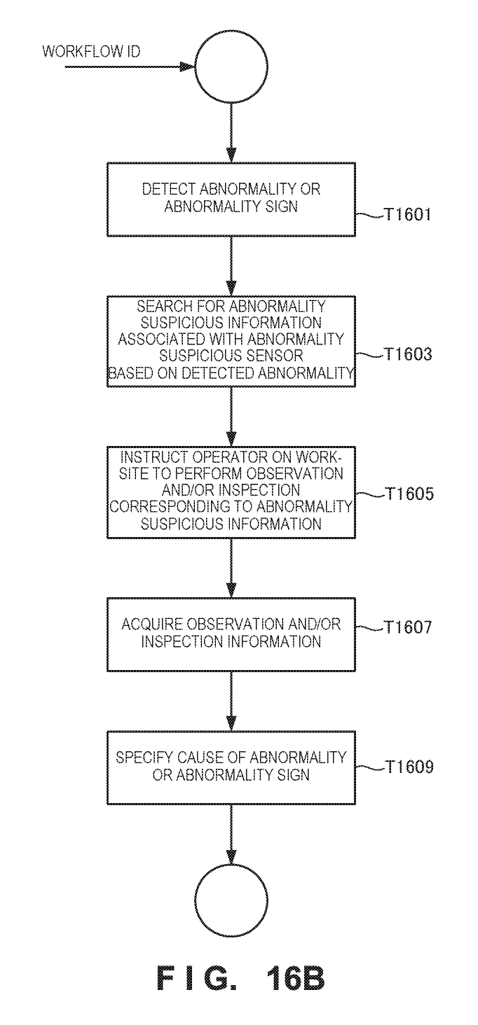

An example in which discrimination is performed in an observation instruction will be described next with reference to FIGS. 16A and 16B. In the example, an information collection method of instructing the operator on work site to observe an abnormality suspicious event accumulated in association with the position of a specified sensor is set. Note that the method of performing discrimination in the observation instruction is not limited to the following example.

FIG. 16A is a view showing an arrangement for implementing the seventh information collection method in the plant management system 200 according to this example embodiment. Note that the same reference numerals as in FIGS. 2, 4, and 10A denote the same constituent elements in FIG. 16A, and a repetitive description thereof will be omitted.

In a plant management system 1600 shown in FIG. 16A, the plant management apparatus 210 includes an abnormality cause information database 1602, an observation/inspection determiner 1613, an observation/inspection instructor 1614, and a cause specifier 1615.

The abnormality cause information database 1602 stores the position and type of abnormality information registered in the past for a specific fault, for example, the association between an abnormality such as a smell, sound, vibration, drop of a screw, flashing, or a liquid on the floor and the cause of the abnormality by referring to the abnormality suspicious information database 402. For a high-ranking sensor in an abnormality suspicious ranking 1612 of sensors from the analysis engine 1011, the observation/inspection determiner 1613 determines whether observation and/or inspection on work site is necessary by referring to the abnormality cause information database 1602. Upon determining that observation and/or inspection on work site is necessary, the observation/inspection instructor 1614 issues a work instruction 1621 via the terminal 220 on work site to the operator 250. Then, upon receiving new observation information 1622 from the terminal 220 on work site, the cause specifier 1615 specifies the cause of abnormality suspicion using the new observation information 1622.

FIG. 16B is a view showing a workflow for implementing the seventh information collection method according to this example embodiment.

In task T1601, the workflow controller 512 causes the analysis engine 1011 to analyze sensor information or abnormality suspicious information and detects an abnormality or an abnormality sign in the plant or sensor. In task T1603, the workflow controller 512 searches the abnormality cause information database 1602 for abnormality cause information associated with an abnormality suspicious sensor based on the detected abnormality. In task T1605, the workflow controller 512 instructs the operator 250 on work site by the terminal 220 to perform observation and/or inspection corresponding to the abnormality suspicious information.

In task T1607, the workflow controller 512 acquires observation and/or inspection information observed by the operator 250 from the terminal 220 on work site. In task T1609, the workflow controller 512 specifies the cause of the abnormality or abnormality sign in the plant or sensor.

(Feature Conversion)

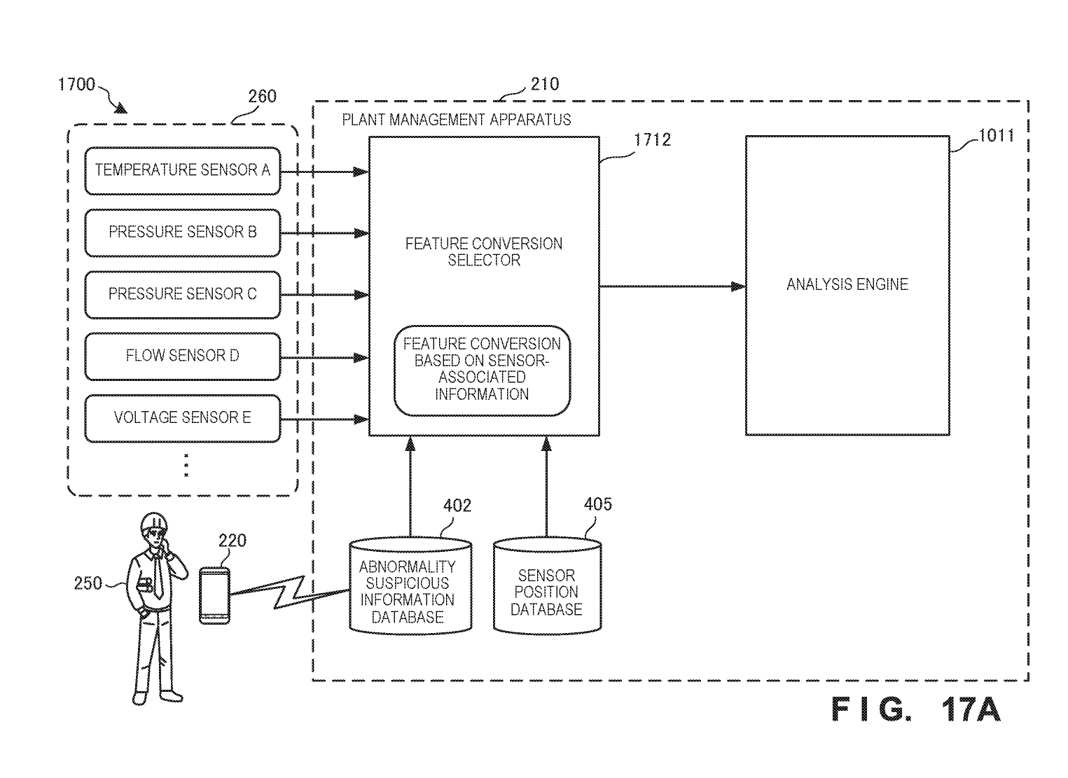

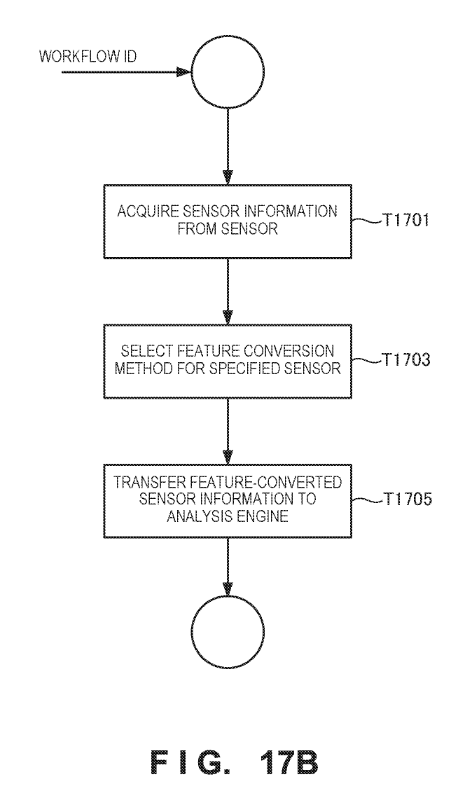

In the eighth information collection method shown in FIGS. 17A and 17B, an information collection method of changing a feature change in data input of a specified sensor is set. Note that although the change of feature conversion in this example is related to setting of the information collection method concerning data collection shown in FIGS. 10A to 11B, this can also be considered as setting of the information collection method concerning data analysis shown in FIGS. 12A to 13B.

FIG. 17A is a view showing an arrangement for implementing the eighth information collection method in the plant management system 200 according to this example embodiment. Note that the same reference numerals as in FIGS. 2 and 4 denote the same constituent elements in FIG. 17A, and a repetitive description thereof will be omitted.

In a plant management system 1700 shown in FIG. 17A, the plant management apparatus 210 includes a feature conversion selector 1712. The feature conversion selector 1712 performs feature conversion for converting sensor information into a component that readily shows the feature to increase the information amount for a sensor specified by sensor-associated information, based on abnormality suspicious information accumulated in the abnormality suspicious information database 402 and a sensor position accumulated in the sensor position database 405, when transmitting sensor information from input of the sensor 260 to the analysis engine 1011. Then, the feature-converted feature information is transmitted to the analysis engine 1011.

For example, for a vibration sensor, time-series data such as the strength (a voltage or the like) of a vibration is converted into a frequency by FFT (Fast Fourier Transform). Then, the representative value of a PSD (Power Spectral Density Function) for each frequency is obtained, and the representative value is obtained while moving the time, thereby generating the time-series data of the PSD for each frequency band. The generated time-series data is sent to the analysis engine 1011. Alternatively, the time-series data of the strength of the vibration is converted into a frequency by FFT, and a resonance frequency is obtained. The resonance frequency is obtained while moving the time, thereby generating time-series data of the resonance frequency. The generated time-series data is sent to the analysis engine 1011. Alternatively, the lightness of an image sensor for each predetermined area is acquired as digital data at a predetermined time interval, thereby generating time-series data of an image component. The generated time-series data is sent to the analysis engine 1011.

The information collection method is set such that such feature conversion is performed for a sensor specified in association with the occurrence of an abnormality suspicious event to convert sensor information into a component that readily shows the feature and increase the information amount. With this processing, the sensor information can be analyzed more accurately and more quickly by the analysis engine 1011.

FIG. 17B is a view showing a workflow for implementing the eighth information collection method according to this example embodiment.

In task T1701, the workflow controller 512 acquires sensor information from a sensor. In task T1703, the workflow controller 512 selects a feature conversion method for a specified sensor. In task T1705, the workflow controller 512 transfers selected sensor information to the analysis engine 1011.

(Setting and End of Information Collection Method)

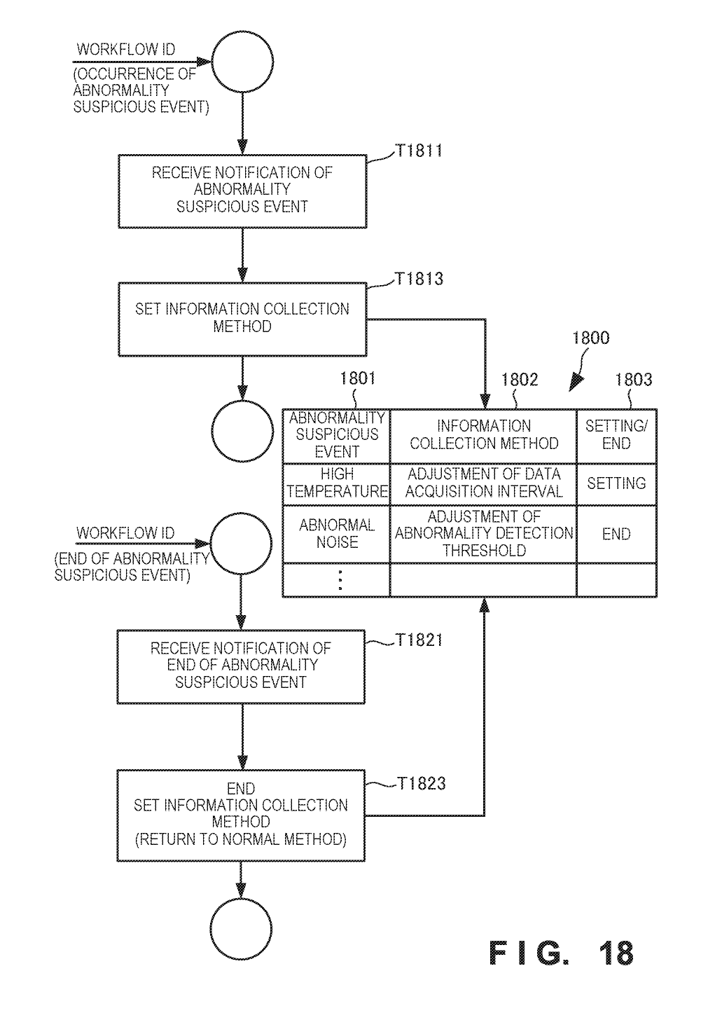

FIG. 18 is a view showing an information collection method control table and a workflow for controlling setting/end of the information collection method according to this example embodiment.

An information collection method control table 1800 is used to control setting/end of the information collection method. In association with an abnormality suspicious event 1801, the information collection method control table 1800 stores an information collection method 1802 discriminated and set based on the occurrence of the abnormality suspicious event 1801, and a flag 1803 representing whether the information collection method is set or ended.

In task T1811, the workflow controller 512 receives a notification of occurrence of an abnormality suspicious event by an occurrence report of the abnormality suspicious event. In task T1813, the workflow controller 512 sets an information collection method concerning a specified sensor. That is, the flag 1803 corresponding to the abnormality suspicious event 1801 and the selected information collection method 1802 and representing whether the information collection method is set or ended is changed to “setting”.

In task T1821, the workflow controller 512 receives a notification of end of the abnormality suspicious event by an end report of the abnormality suspicious event. In task T1823, the workflow controller 512 ends the set information collection method in accordance with the specified sensor. That is, the flag 1803 corresponding to the abnormality suspicious event 1801 and the selected information collection method 1802 and representing whether the information collection method is set or ended is changed from “set” to “end”.

Note in the processing shown in FIG. 18, the alarm transmitter/receiver 511 of the workflow apparatus 510 may receive the report of the abnormality suspicious event as an alarm, and the workflow controller 512 may control the setting and end of the information collection method.

According to this example embodiment, information collection concerning a sensor and needed to analyze the state of an abnormality suspicious event using the information of the abnormality suspicious event suspected to be abnormal by the operator on work site or the analysis method of collected information or a presentation method based on an analysis result is set as an information collection method. As a result, it is possible to actively incorporate the sense or experience of the operator who observes or inspects the plant on work site in plant management processing.

### Other Example Embodiments

While the invention has been particularly shown and described with reference to example embodiments thereof, the invention is not limited to these example embodiments. It will be understood by those of ordinary skill in the art that various changes in form and details may be made therein without departing from the spirit and scope of the present invention as defined by the claims.

The present invention is applicable to a system including a plurality of devices or a single apparatus. The present invention is also applicable even when a plant management program for implementing the functions of example embodiments is supplied to the system or apparatus directly or from a remote site. Hence, the present invention also incorporates the program installed in a computer to implement the functions of the present invention by the computer, a medium storing the program, and a WWW (World Wide Web) server that causes a user to download the program. Especially, the present invention incorporates at least a non-transitory computer readable medium storing a program that causes a computer to execute processing steps included in the above-described example embodiments.

### Other Expressions of Example Embodiments

Some or all of the above-described embodiments can also be described as in the following supplementary notes but are not limited to the followings.

(Supplementary Note 1)

There is provided a plant management system comprising:

an acquirer that acquires at least a position in which an abnormality suspicious event suspected to be abnormal by an operator on a work site has occurred;

a sensor specifier that specifies a sensor associated with the abnormality suspicious event based on the at least a position in which the abnormality suspicious event has occurred; and

a setter that sets an information collection method in accordance with the specified sensor.

(Supplementary Note 2)

In the plant management system according to supplementary note 1, the acquirer acquires the position in which the abnormality suspicious event has occurred, based on a position of a terminal carried by the operator.

(Supplementary Note 3)

In the plant management system according to supplementary note 1 or 2, the sensor specifier specifies a sensor located within a predetermined distance from the position in which the abnormality suspicious event has occurred.

(Supplementary Note 4)

In the plant management system according to any one of supplementary notes 1 to 3, the sensor specifier specifies a sensor located at a position associated with the position in which the abnormality suspicious event has occurred, in correspondence with a type of the abnormality suspicious event.

(Supplementary Note 5)

In the plant management system according to any one of supplementary notes 1 to 4, the acquirer further acquires at least one of the type of the abnormality suspicious event and an occurrence time of the abnormality suspicious event, and

the sensor specifier further specifies the sensor based on the at least one of the type and the occurrence time of the abnormality suspicious event.

(Supplementary Note 6)

The plant management system according to supplementary note 5, further comprises an accumulator that accumulates the position in which the abnormality suspicious event has occurred and the at least one of the type and the occurrence time of the abnormality suspicious event in association with each other.

(Supplementary Note 7)

In the plant management system according to any one of supplementary notes 1 to 6, the information collection method is a method for discriminating information collection by the specified sensor from information collection by other sensors.

(Supplementary Note 8)

In the plant management system according to supplementary note 7, the setter sets an information collection method of discriminating data input from the specified sensor from data input from other sensors.

(Supplementary Note 9)

In the plant management system according to supplementary note 8, the setter limits the data input to the specified sensor.

(Supplementary Note 10)

In the plant management system according to supplementary note 8 or 9, the setter changes an interval of the data input from the specified sensor.

(Supplementary Note 11)

In the plant management system according to any one of supplementary notes 8 to 10, the setter changes feature conversion of the data input from the specified sensor.

(Supplementary Note 12)

In the plant management system according to any one of supplementary notes 7 to 11, the setter sets an information collection method of discriminating analysis of data from the specified sensor from analysis of data from other sensors.

(Supplementary Note 13)

In the plant management system according to supplementary note 12, the setter sets an information collection method of changing a threshold for abnormality detection by the specified sensor.

(Supplementary Note 14)

In the plant management system according to supplementary note 12 or 13, the setter sets an information collection method of changing an analysis interval to analyze the data of the specified sensor.

(Supplementary Note 15)

In the plant management system according to any one of supplementary notes 7 to 14, the setter sets an information collection method of discriminating display of the specified sensor from display of other sensors.

(Supplementary Note 16)

In the plant management system according to supplementary note 15, the setter sets an information collection method of adding information of the abnormality suspicious event to the specified sensor during ranking display of abnormality suspicious sensors.

(Supplementary Note 17)

In the plant management system according to supplementary note 15 or 16, the setter sets an information collection method of changing an order of the specified sensor in the ranking display of the abnormality suspicious sensors.

(Supplementary Note 18)

In the plant management system according to any one of supplementary notes 7 to 17, the setter sets an information collection method of instructing the operator on work site to observe the abnormality suspicious event, in association with the position of the specified sensor.

(Supplementary Note 19)

In the plant management system according to any one of supplementary notes 1 to 18, the acquirer acquires information representing disappearance of the abnormality suspicious event from the operator on work site, and

the setter ends the information collection method set in accordance with the specified sensor.

(Supplementary Note 20)

There is provided a plant management method comprising:

acquiring at least a position in which an abnormality suspicious event suspected to be abnormal by an operator on work site has occurred;

specifying a sensor associated with the abnormality suspicious event based on the at least a position in which the abnormality suspicious event has occurred; and

setting an information collection method in accordance with the specified sensor.

(Supplementary Note 21)

There is provided a plant management apparatus comprising:

an acquirer that acquires at least a position in which an abnormality suspicious event suspected to be abnormal has occurred from a terminal carried by an operator on work site;

a sensor specifier that specifies a sensor associated with the abnormality suspicious event based on the at least a position in which the abnormality suspicious event has occurred; and an instructor that instructs to set an information collection method in accordance with the specified sensor.

(Supplementary Note 22)

There is provided a plant management program for causing a computer to execute a method, comprising:

displaying, on a terminal carried by an operator on work site, a list of tasks to be performed by the operator;

acquiring, from the terminal, at least a position in which an abnormality suspicious event suspected to be abnormal has occurred; and

presenting information of a sensor associated with the abnormality suspicious event, the sensor being specified based on the at least a position in which the abnormality suspicious event has occurred.

(Supplementary Note 23)

There is provided a plant management program for causing a computer to execute a method, comprising:

acquiring at least a position in which an abnormality suspicious event suspected to be abnormal has occurred from a terminal carried by an operator on work site;

specifying a sensor associated with the abnormality suspicious event based on the at least a position in which the abnormality suspicious event has occurred; and

instructing to set an information collection method in accordance with the specified sensor.

(Supplementary Note 24)

There is provided a plant management program for causing a computer to execute a method, comprising:

accumulating, in an accumulator, a position in which an abnormality suspicious event suspected to be abnormal has occurred and which is acquired from a terminal carried by an operator on work site;

determining an abnormality suspicious sensor associated with the abnormality suspicious event by referring to the accumulator; and

instructing to set an information collection method of a sensor specified based on the position in which the abnormality suspicious event has occurred, with reflecting occurrence of the abnormality suspicious event on ranking display of the abnormality suspicious sensor.

1. A plant management system comprising:
an acquirer that acquires at least a position in which an abnormality suspicious event suspected to be abnormal by an operator on a work site has occurred;
a sensor specifier that specifies a sensor associated with the abnormality suspicious event based on the at least a position in which the abnormality suspicious event has occurred; and
a setter that sets an information collection method in accordance with the specified sensor.

2. (canceled)

3. The plant management system according to claim 1, wherein the sensor specifier specifies a sensor located within a predetermined distance from the position in which the abnormality suspicious event has occurred.

4. The plant management system according to claim 1, wherein the sensor specifier specifies a sensor located at a position associated with the position in which the abnormality suspicious event has occurred, in correspondence with a type of the abnormality suspicious event.

5. The plant management system according to claim 1, wherein the acquirer further acquires at least one of the type of the abnormality suspicious event and an occurrence time of the abnormality suspicious event, and
the sensor specifier further specifies the sensor based on the at least one of the type and the occurrence time of the abnormality suspicious event.

6. The plant management system according to claim 5, further comprising an accumulator that accumulates the position in which the abnormality suspicious event has occurred and the at least one of the type and the occurrence time of the abnormality suspicious event in association with each other.

7. The plant management system according to claim 1, wherein the information collection method is a method for discriminating information collection by the specified sensor from information collection by other sensors.

8. The plant management system according to claim 7, wherein the setter sets an information collection method of discriminating data input from the specified sensor from data input from other sensors.

9. The plant management system according to claim 8, wherein the setter limits the data input to the specified sensor.

10. The plant management system according to claim 8, wherein the setter changes an interval of the data input from the specified sensor.

11. The plant management system according to claim 8, wherein the setter changes feature conversion of the data input from the specified sensor.

12. The plant management system according to claim 7, wherein the setter sets an information collection method of discriminating analysis of data from the specified sensor from analysis of data from other sensors.

13. The plant management system according to claim 12, wherein the setter sets an information collection method of changing a threshold for abnormality detection by the specified sensor.

14. The plant management system according to claim 12, wherein the setter sets an information collection method of changing an analysis interval to analyze the data of the specified sensor.

15. The plant management system according to claim 7, wherein the setter sets an information collection method of discriminating display of the specified sensor from display of other sensors.

16. The plant management system according to claim 15, wherein the setter sets an information collection method of adding information of the abnormality suspicious event to the specified sensor during ranking display of abnormality suspicious sensors.

17. The plant management system according to claim 15, wherein the setter sets an information collection method of changing an order of the specified sensor in the ranking display of the abnormality suspicious sensors.

18. The plant management system according to claim 7, wherein the setter sets an information collection method of instructing the operator on work site to observe the abnormality suspicious event, in association with the position of the specified sensor.

19. The plant management system according to claim 1, wherein the acquirer acquires information representing disappearance of the abnormality suspicious event from the operator on work site, and
the setter ends the information collection method set in accordance with the specified sensor.

20. (canceled)

21. A plant management apparatus comprising:
an acquirer that acquires at least a position in which an abnormality suspicious event suspected to be abnormal has occurred from a terminal carried by an operator on work site;
a sensor specifier that specifies a sensor associated with the abnormality suspicious event based on the at least a position in which the abnormality suspicious event has occurred; and
an instructor that instructs to set an information collection method in accordance with the specified sensor.

22. (canceled)

23. A non-transitory computer-readable storage medium storing a plant management program for causing a computer to execute a method, comprising:
acquiring at least a position in which an abnormality suspicious event suspected to be abnormal has occurred from a terminal carried by an operator on work site;
specifying a sensor associated with the abnormality suspicious event based on the at least a position in which the abnormality suspicious event has occurred; and
instructing to set an information collection method in accordance with the specified sensor.

24. (canceled)
